(19) United States
(12) Patent Application Publication
(10) Pub. No.: US 2019/0084311 A1
(43) Pub. Date: Mar. 21, 2019

(54) Liquid Supply Unit

(71) Applicant: Seiko Epson Corporation, Tokyo (JP)

(72) Inventors: Kazumasa Harada, Matsumoto-shi (JP); Kazuhisa Kawakami, Matsumoto-shi (JP)

(21) Appl. No.: 16/197,080

(22) Filed: Nov. 20, 2018

Related U.S. Application Data
(63) Continuation of application No. 14/988,353, filed on Jan. 5, 2016.

(30) Foreign Application Priority Data
Jan. 6, 2015 (JP) 2015-000674
Aug. 5, 2015 (JP) 2015-154817

(51) Int. Cl. B41J 2/175

(52) U.S. Cl. CPC B41J 2/17526; B41J 2/17513; B41J 2/1752; B41J 2/1753; B41J 2/17553

(57) ABSTRACT

A liquid supply unit adapted to supply a liquid to a liquid ejection device is provided. The liquid ejection device includes an engagement hole, an engaged portion, an electrode portion having an electrode pin, and an introduction portion. The liquid supply unit includes first and second housings and a biasing member. The first housing has a liquid containing portion, a liquid supply portion supplying the liquid from the liquid containing portion to the introduction portion, and an engagement protrusion engageable with the engagement hole. The second housing has a terminal portion coming into electrical contact with the electrode portion and an engagement portion engageable with the engaged portion. The biasing member biases the second housing in a direction away from the first housing in a state in which the liquid supplying unit is attached to the liquid ejection device.

### BACKGROUND OF THE INVENTION

### 1. Technical Field

The present invention relates to a liquid supply unit and the like.

### 2. Related Art

In inkjet printers, which are an example of liquid ejection devices, printing onto a print medium such as print paper is performed by discharging ink, which is an example of a liquid, from a print head onto the print medium. Inkjet printers having a configuration in which ink is supplied from an ink cartridge, which is an example of a liquid supply unit, are known. For example, a technology in which a lever serving as an engagement mechanism is provided on a side wall of an ink cartridge is known (JP-A-2007-230249). According to this related art, when the ink cartridge is attached to a holder, the lever of the ink cartridge engages with an engagement portion of the holder and is fixed. During removal, the engagement of the ink cartridge with the engagement portion is released by a user pressing the lever, and thus the ink cartridge can be removed from the holder. Moreover, JP-A-2013-141804 discloses a technology in which a lever serving as an engagement mechanism is provided in a holder on a carriage of a printing device. In the printing device of JP-A-2013-141804, when an ink cartridge is attached to a holding mechanism, the ink cartridge engages with the lever and is fixed. During removal, the engagement of the ink cartridge with the lever is released by the user pressing the lever, and thus the ink cartridge can be removed from the holding mechanism.

However, with the reduction in the size of ink cartridges, the size of levers has also been reduced, and there are cases where the user finds it difficult to correctly recognize the pressing position on the lever or to correctly press the lever. For this reason, there is a demand for a novel engagement mechanism that has not been proposed by related art.

### BRIEF SUMMARY OF THE INVENTION

Some aspects of the invention can solve at least the above-described problem and may be realized as the following modes or application examples.

### Application Example 1

A liquid supply unit, adapted to supply a liquid to a liquid ejection device including a first engaged portion, a second engaged portion, an electrode portion having an electrode pin, and a liquid introduction portion, is provided. The liquid supply unit includes a first housing, a second housing, and a biasing portion. The first housing has a liquid containing portion, a liquid supply portion adapted to supply the liquid from the liquid containing portion to the liquid introduction portion, and a first engagement portion engageable with the first engaged portion. The second housing has a terminal portion adapted to come into electrical contact with the electrode portion and a second engagement portion engageable with the second engaged portion. The biasing portion biases the second housing in a direction away from the first housing in a state in which the liquid supply unit is attached to the liquid ejection device.

With this configuration, a state in which the first engagement portion engages with the first engaged portion and a state in which the second engagement portion engages with the second engaged portion as well as a state in which the electrode portion and the terminal portion are in electrical contact with each other can be achieved by the biasing member biasing the second housing in the direction away from the first housing. Moreover, the state in which the first engagement portion engages with the first engaged portion and the state in which the second engagement portion engages with the second engaged portion as well as the state in which the electrode portion and the terminal portion are in electrical contact with each other can be released by displacing the second housing in a direction toward the first housing. Thus, it is possible to attach/remove the liquid supply unit to/from the liquid ejection device using a novel engagement mechanism that has not been proposed by related art.

### Application Example 2

A liquid supply unit, adapted to supply a liquid to a liquid ejection device including a first engaged portion, a second engaged portion, an electrode portion having an electrode pin, and a liquid introduction portion, is provided. The liquid supply unit includes a first housing, a second housing, and a biasing portion. The first housing has a first engagement portion engageable with the first engaged portion. The second housing has a liquid containing portion, a liquid supply portion adapted to supply the liquid from the liquid containing portion to the liquid introduction portion, a terminal portion adapted to come into electrical contact with the electrode portion, and a second engagement portion engageable with the second engaged portion. The biasing portion biases the second housing in a direction away from the first housing in a state in which the liquid supply unit is attached to the liquid ejection device.

With this configuration, the state in which the first engagement portion engages with the first engaged portion and the state in which the second engagement portion engages with the second engaged portion as well as the state in which the electrode portion and the terminal portion are in electrical contact with each other can be achieved by the biasing member biasing the second housing in the direction away from the first housing. Moreover, the state in which the first engagement portion engages with the first engaged portion and the state in which the second engagement portion engages with the second engaged portion as well as the state in which the electrode portion and the terminal portion are in electrical contact with each other can be released by displacing the second housing in a direction toward the first housing. Thus, it is possible to attach/remove the liquid supply unit to/from the liquid ejection device using a novel engagement mechanism that has not been proposed by related art.

### Application Example 3

The liquid introduction portion of the liquid ejection device may include a liquid introduction port and a seal portion surrounding the liquid introduction port. The liquid supply portion of the above-described liquid supply unit may include a liquid supply port and a wall portion surrounding the liquid supply port. When a surface where the wall portion and the seal portion abut against each other in the state in which the liquid supply unit is attached to the liquid ejection device is defined as a reference surface, the second housing may be biased by the biasing portion in a direction along the reference surface.

With this configuration, the state in which the first engagement portion engages with the first engaged portion and the state in which the second engagement portion engages with the second engaged portion as well as the state in which electrode portion and the terminal portion are in electrical contact with each other can be achieved by the biasing member biasing the second housing in the direction away from the first housing.

### Application Example 4

In the above-described liquid supply unit, in the state in which the liquid supply unit is attached to the liquid ejection device, the first engagement portion may abut against the first engaged portion in a direction that intersects the direction along the reference surface, and the second engagement portion may abut against the second engaged portion in the direction that intersects the direction along the reference surface.

With this configuration, it is no longer necessary to provide a lever structure for achieving the engaged state of the first engagement portion and the engaged state of the second engagement portion in either the liquid supply unit or the liquid ejection device.

### Application Example 5

In the above-described liquid supply unit, the first housing may have a first operating portion that is used to elastically deform the biasing portion and move a position of the first housing relative to the second housing, and in the state in which the liquid supply unit is attached to the liquid ejection device, the first operating portion may be located on a side of the liquid containing portion opposite to the liquid supply portion with respect to a direction that intersects the direction along the reference surface.

With this configuration, the state in which the first engagement portion engages with the first engaged portion and the state in which the second engagement portion engages with the second engaged portion as well as the state in which the electrode portion and the terminal portion are in electrical contact with each other can be readily released.

### Application Example 6

In the above-described liquid supply unit, the second housing may have a second operating portion that is used to elastically deform the biasing portion and move a position of the second housing relative to the first housing, and in the state in which the liquid supply unit is attached to the liquid ejection device, the second operating portion may be located on a side of the liquid containing portion opposite to the liquid supply portion with respect to a direction that intersects the direction along the reference surface.

With this configuration, the state in which the first engagement portion engages with the first engaged portion and the state in which the second engagement portion engages with the second engaged portion and the state in which the electrode portion and the terminal portion are in electrical contact with each other can be readily released.

### Application Example 7

In the above-described liquid supply unit, the first housing may have a first operating portion that is used to elastically deform the biasing portion and move a position of the first housing relative to the second housing, the second housing may have a second operating portion that is used to elastically deform the biasing portion and move a position of the second housing relative to the first housing, and in the state in which the liquid supply unit is attached to the liquid ejection device, the first operating portion and the second operating portion may be provided on the same surface of outer surfaces of the liquid supply unit.

With this configuration, the state in which the first engagement portion engages with the first engaged portion and the state in which the second engagement portion engages with the second engaged portion and the state in which the electrode portion and the terminal portion are in electrical contact with each other can be readily released.

### Application Example 8

In the above-described liquid supply unit, the first housing may have a first operating portion that is used to elastically deform the biasing portion and move a position of the first housing relative to the second housing, the second housing may have a second operating portion that is used to elastically deform the biasing portion and move a position of the second housing relative to the first housing, and in the state in which the liquid supply unit is attached to the liquid ejection device, at least a portion of the first operating portion and at least a portion of the second operating portion may have equal heights from the reference surface in a direction that intersects the direction along the reference surface.

With this configuration, the state in which the first engagement portion engages with the first engaged portion and the state in which the second engagement portion engages with the second engaged portion and the state in which the electrode portion and the terminal portion are in electrical contact with each other can be readily released.

### Application Example 9

In the above-described liquid supply unit, in the state in which the liquid supply unit is attached to the liquid ejection device, a side wall of the first housing that extends in a direction that intersects the direction along the reference surface may be provided with a first guide portion, and a side wall of the second housing that extends in the direction that intersects the direction along the reference surface may be provided with a second guide portion adapted to come into contact with the first guide portion.

With this configuration, the position of the first housing relative to the second housing can be stabilized by the first guide portion and the second guide portion coming into contact with each other.

### BRIEF DESCRIPTION OF THE DRAWINGS

The invention will be described with reference to the accompanying drawings, wherein like numbers reference like elements.

FIG. 1 is a perspective view showing a schematic configuration of a liquid ejection system according to an embodiment of the invention.

FIG. 2 is a perspective view showing a carriage unit and cartridges according to a first embodiment.

FIG. 3 is a perspective view showing the carriage unit according to the first embodiment.

FIG. 4 is a plan view showing a circuit board according to the first embodiment.

FIG. 5 is a perspective view showing the carriage unit and the cartridges according to the first embodiment.

FIG. 6 is a cross-sectional view showing the carriage unit according to the first embodiment.

FIG. 7 is a perspective view showing a cartridge according to the first embodiment.

FIG. 8 is an exploded perspective view showing the cartridge according to the first embodiment.

FIG. 9 is a perspective view showing a container case according to the first embodiment.

FIG. 10 is a perspective view showing a second housing according to the first embodiment.

FIG. 11 is a cross-sectional view of the cartridge according to the first embodiment.

FIG. 12 is a cross-sectional view showing the cartridge and the carriage unit according to the first embodiment.

FIG. 13 is a cross-sectional view showing the cartridge and the carriage unit according to the first embodiment.

FIG. 14 is a cross-sectional view showing the cartridge and the carriage unit according to the first embodiment.

FIG. 15 is a cross-sectional view showing the cartridge and the carriage unit according to the first embodiment.

FIG. 16 is a cross-sectional view of a cartridge according to a second embodiment.

FIG. 17 is a perspective view showing the configuration of a holder according to a third embodiment.

FIG. 18 is a cross-sectional view taken along line A-A in FIG. 17.

FIG. 19 is a perspective view showing a cartridge according to the third embodiment.

FIG. 20 is a cross-sectional view of the cartridge according to the third embodiment.

FIG. 21 is a cross-sectional view showing the cartridge and the holder according to the third embodiment.

FIG. 22 is a cross-sectional view showing the cartridge and the holder according to the third embodiment.

FIG. 23 is a cross-sectional view showing the cartridge and the holder according to the third embodiment.

FIG. 24 is a cross-sectional view showing the cartridge and the holder according to the third embodiment.

FIG. 25 is a diagram for explaining a schematic configuration of a liquid supply unit according to Modification 1.

### DETAILED DESCRIPTION OF THE PREFERRED EMBODIMENTS

The following describes an embodiment of the invention with reference to the drawings, taking a liquid ejection system as an example. In the drawings, in order to show individual components in recognizable sizes, the components and members may be shown on different scales.

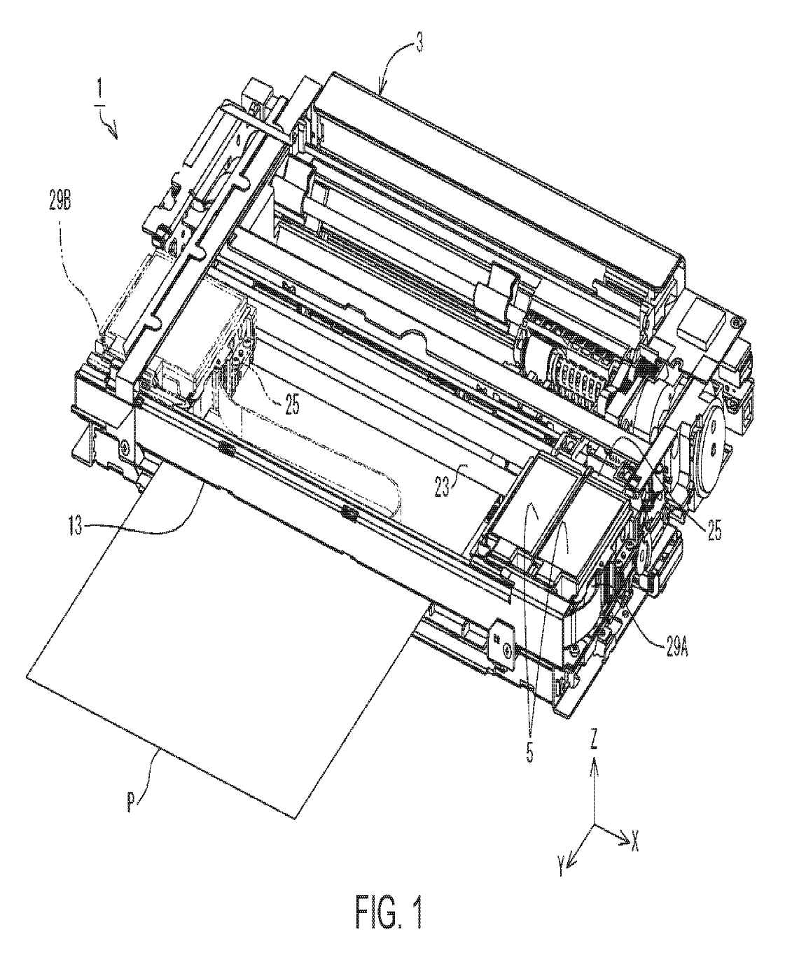

As shown in FIG. 1, a liquid ejection system 1 of an embodiment of the invention has a printer 3, which is an example of a liquid ejection device, and cartridges 5, which are an example of a liquid supply unit. The cartridges 5 can contain ink, which is an example of a liquid. The ink is not limited to either one of water-based ink and oil-based ink. Any of ink having a configuration in which a solute is dissolved in a water-based solvent, ink having a configuration in which a dispersoid is dispersed in a water-based dispersion medium, ink having a configuration in which a solute is dissolved in an oil-based solvent, and ink having a configuration in which a dispersoid is dispersed in an oil-based dispersion medium may be used. In the liquid ejection system 1, printing onto a recording medium P can be performed using ink contained in the cartridges 5. In the printer 3, a paper discharge portion 13 from which the recording medium P can be discharged to the outside of the printer 3 is formed. The printed recording medium P is discharged to the outside of the printer 3 from the paper discharge portion 13.

It should be noted that in FIG. 1, X-, Y-, and Z-axes, which are coordinate axes that are orthogonal to one another, are shown. The X-, Y-, and Z-axes may also be shown in the drawings described below, as necessary. In the present embodiment, a state in which the printer 3 is disposed in a horizontal plane (XY plane) defined by the X-axis and the Y-axis is the state in which the printer 3 is used. The Z-axis is the axis that is orthogonal to that horizontal plane. In the state in which the printer 3 is used, the Z-axis direction is a vertically upward direction. Also, in the state in which the printer 3 is used, the −Z-axis direction in FIG. 1 is a vertically downward direction. It should be noted that with respect to each of the X-, Y-, and Z-axes, the direction of the arrow indicates the + (positive) direction, and the direction opposite to the direction of the arrow indicates the − (negative) direction.

As shown in FIG. 1, the printer 3 according to the present embodiment has a conveyance roller 23 and a carriage unit 25. Moreover, the printer 3 has a medium conveyance mechanism (not shown) and a carriage conveyance mechanism (not shown). The medium conveyance mechanism conveys the recording medium P in the Y-axis direction using the power of a motor (not shown). The carriage conveyance mechanism conveys the carriage unit 25 along the X-axis using the power of a motor (not shown). The carriage conveyance mechanism enables the carriage unit 25 to move backward and forward along the X-axis between a first standby position 29A and a second standby position 29B. In the present embodiment, the carriage unit 25 can move within the range between the first standby position 29A and the second standby position 29B.

Here, the direction along the X-axis is not limited to the direction that is perfectly parallel to the X-axis, and may also include directions that are inclined due to an error, a tolerance, or the like, except for the direction that is orthogonal to the X-axis. Similarly, the direction along the Y-axis is not limited to the direction that is perfectly parallel to the Y-axis, and may also include directions that are inclined due to an error, a tolerance, or the like, except for the direction that is orthogonal to the Y-axis. The direction along the Z-axis is not limited to the direction that is perfectly parallel to the Z-axis, and may also include directions that are inclined due to an error, a tolerance, or the like, except for the direction that is orthogonal to the Z-axis. That is to say, a direction along a given axis or plane is not limited to the direction that is perfectly parallel to the given axis or plane, and may also include directions that are inclined due to an error, a tolerance, or the like, except for the direction that is orthogonal to the given axis or plane.

The carriage unit 25 is located on the Z-axis direction side relative to a conveyance path for the recording medium P. A print head, which will be described later, is installed in the carriage unit 25. The print head faces the conveyance path of the recording medium P while being located on the Z-axis direction side relative to the conveyance path for the recording medium P. In the liquid ejection system 1 having the above-described configuration, driving of the medium conveyance mechanism is controlled by a control unit (not shown), and the recording medium P is conveyed in the Y-axis direction. At this time, while moving the carriage unit 25 backward and forward along the X-axis by controlling driving of the carriage conveyance mechanism, the control unit causes ink droplets to be discharged at predetermined positions by controlling driving of the print head. As a result of the above-described operation, dots are formed on the recording medium P, and recording onto this recording medium P based on recording information such as image data is performed.

### First Embodiment

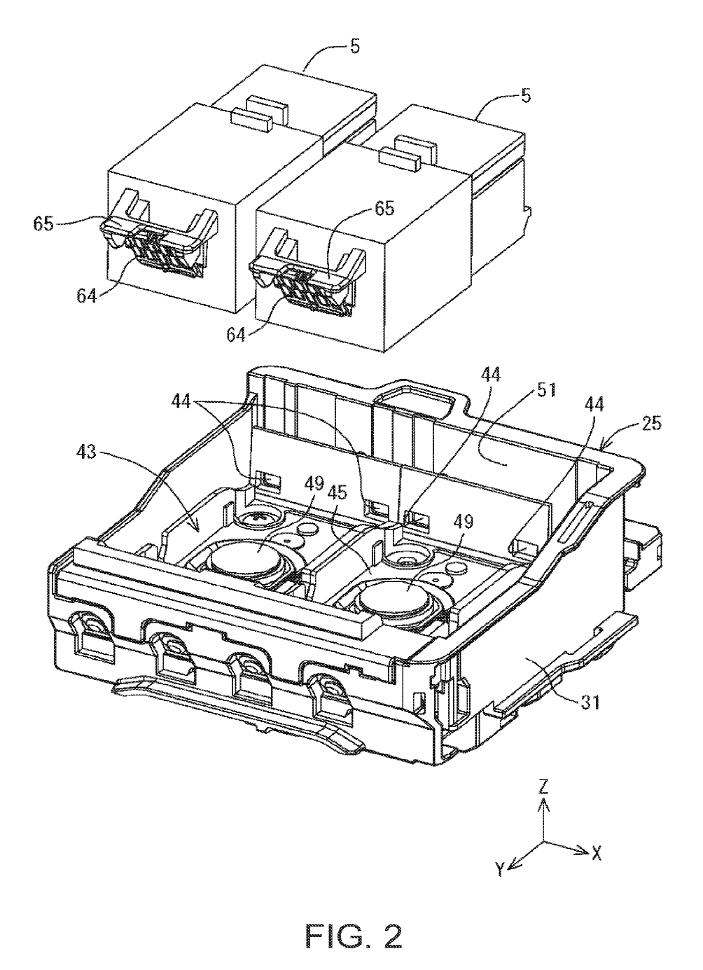

As shown in FIG. 2, the carriage unit 25 has a holder 31. It should be noted that the X-, Y-, and Z-axes in FIG. 2 correspond to the X-, Y-, and Z-axes with respect to the liquid ejection system 1 shown in FIG. 1. That is to say, the X-, Y-, and Z-axes in FIG. 2 mean the X-, Y-, and Z-axes in a state in which the carriage unit 25 is installed in the liquid ejection system 1. Hereinafter, in the case where the X-, Y-, and Z-axes are provided in a drawing showing a component or a unit of the liquid ejection system 1, those X-, Y-, and Z-axes mean the X-, Y-, and Z-axes in a state in which this component or unit is installed in the liquid ejection system 1.

The cartridges 5 are installed in the holder 31. A recess 43 is formed in the holder 31. The recess 43 is formed in such a manner as to be recessed in the −Z-axis direction. The cartridges 5 are attached inside the recess of the holder 31. In the present embodiment, each cartridge 5 is configured such that it can be removably attached to the holder 31. Engagement holes 44 are formed in the holder 31. Moreover, engagement protrusions (described later), which are not shown, are provided at an end portion of the cartridge 5 with respect to the −Y-axis direction. When the cartridge 5 is attached inside the recess 43 of the holder 31, the engagement protrusions of the cartridge 5 engage with the corresponding engagement holes 44 of the holder 31.

The cartridges 5 contain ink, which is an example of a liquid. In the present embodiment, a plurality of cartridges 5 can be attached to the holder 31. In the present embodiment, two cartridges 5 can be attached to the holder 31. However, the number of cartridges 5 is not limited to two, and may be one or may be three or more. It should be noted that “a plurality of” as used herein means a number that is equal to or greater than two.

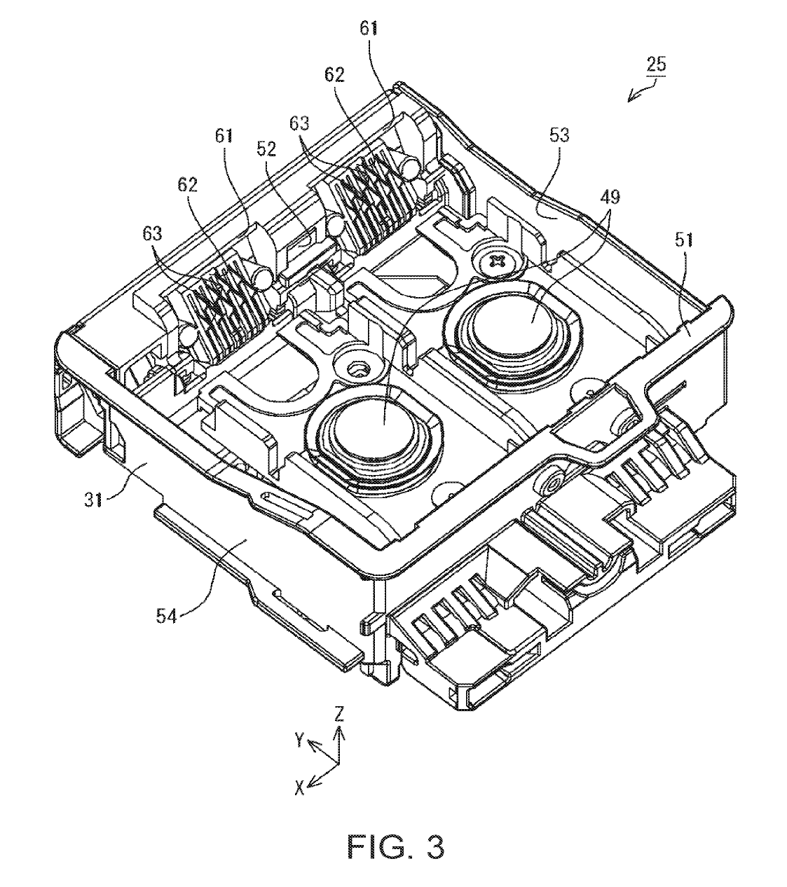

Two ink introduction portions 49 are provided in a bottom portion 45 within the recess 43. As shown in FIG. 3, the holder 31 has a side wall 51 and a side wall 52 that is located on the opposite side to the side wall 51 (with respect to the Y-axis direction) with the two ink introduction portions 49 interposed therebetween along the Y-axis. Also, a side wall 53 and a side wall 54 are provided in respective positions that oppose each other along the X-axis, with the two ink introduction portions 49 interposed therebetween. The side wall 53 is located on the −X-axis direction side relative to the two ink introduction portions 49. The side wall 54 is located on the X-axis direction side relative to the two ink introduction portions 49. The side wall 51, the side wall 52, the side wall 53, and the side wall 54 each project from the bottom portion 45 in the Z-axis direction. It should be noted that the side walls 51 to 54 are not necessarily required to be orthogonal to the bottom portion 45, and it is sufficient if those side walls intersect the bottom portion 45. Moreover, the bottom portion 45 is surrounded by the side wall 51, the side wall 52, the side wall 53, and the side wall 54. The recess 43 is thus demarcated.

Two engaged portions 61 and two contact mechanisms 62 are provided on the side wall 52. The two engaged portions 61 are lined up along the X-axis. The two contact mechanisms 62 are lined up along the X-axis. It should be noted that the contact mechanisms 62 are an example of an electrode portion, and have a plurality of electrode pins 63. Here, as shown in FIG. 2, each of the two cartridges 5 is provided with a circuit board 64 and an engagement portion 65. In the cartridge 5, the engagement portion 65 is provided at an end portion with respect to the Y-axis direction. It should be noted that the engagement holes 44 are formed in the side wall 51 of the holder 31.

The circuit board 64 is electrically connected to a storage device (not shown) such as a non-volatile memory. The contact mechanisms 62 shown in FIG. 3 are configured to be electrically connectable to the corresponding storage devices provided in the circuit boards 64 of the cartridges 5. Moreover, the engaged portions 61 shown in FIG. 3 are configured to be engageable with the corresponding engagement portions 65 of the cartridges 5. When the cartridges 5 are attached to the holder 31, the engagement portions 65 of the cartridges 5 engage with the corresponding engaged portions 61 of the holder 31.

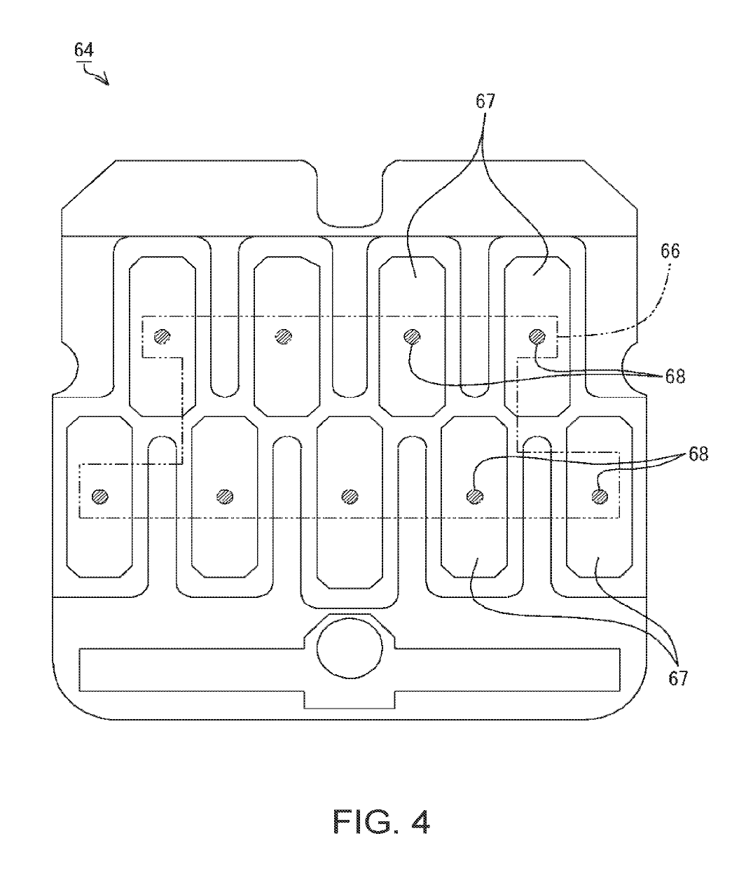

Here, as shown in FIG. 4, each circuit board 64 has a terminal portion 66. The circuit board 64 has a plurality of terminals 67. The plurality of terminals 67 each have a contact portion 68 that can come into electrical contact with the corresponding electrode pin 63 of the contact mechanism 62. The functional portion in which the plurality of contact portions 68 that can be come electrical contact with the electrode pins 63 of the contact mechanism 62 are present is referred to as the terminal portion 66. The terminal portion 66 may also be provided on a substrate. In the present embodiment, at least a part of the plurality of terminals 67 is connected to the storage device (not shown), which is provided in the circuit board 64. Moreover, in the present embodiment, as an example of the plurality of terminals 67, a plurality of metal pads serving as the terminals 67 are arranged on the circuit board 64. Then, in a state in which a cartridge 5 is attached to the holder 31, the storage device, which is provided in the circuit board 64 of that cartridge 5, and a control circuit (not shown) of the printer 3 are electrically connected to each other via the contact mechanism 62. Thus, various types of information are transmitted between the storage device, which is provided in the circuit board 64 of the cartridge 5, and the control circuit of the printer 3.

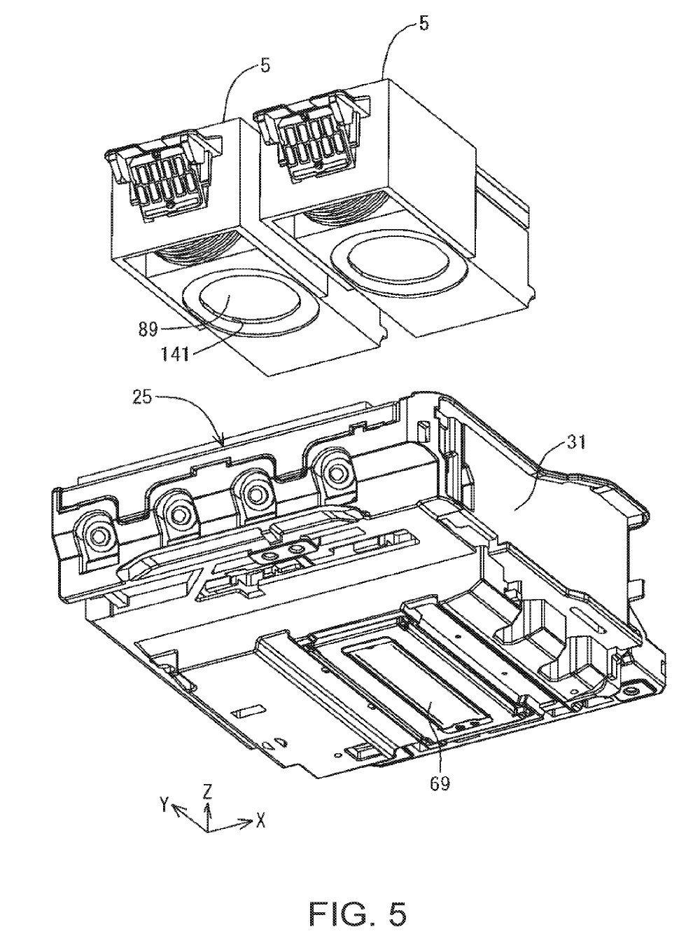

As shown in FIG. 5, the carriage unit 25 has the print head 69. In the carriage unit 25, the print head 69 is provided on the −Z-axis direction side of the holder 31. Ink is supplied to the print head 69 from the two cartridges 5 via the ink introduction portions 49 (FIG. 2). The print head 69 discharges the ink, which is supplied from the two cartridges 5, as ink droplets from nozzles (not shown). As described above, the print head 69 is installed in the carriage unit 25. Therefore, the print head 69 can be conveyed along the X-axis by the carriage conveyance mechanism via the carriage unit 25. While the position of the print head 69 relative to the recording medium P is changed by the medium conveyance mechanism and the carriage conveyance mechanism, ink droplets are discharged from the print head 69, and in this manner printing onto the recording medium P is performed.

It should be noted that in the printer 3, the directions in which the print head 69 is conveyed via the carriage unit 25 are defined as the X-axis direction and the −X-axis direction, and the direction in which the recording medium P is conveyed is defined as the Y-axis direction. In addition, the direction that is orthogonal to both of the X-axis direction and the Y-axis direction is the Z-axis direction. In a state in which the printer 3 is used, the X-axis direction and the Y-axis direction individually constitute horizontal directions, and the Z-axis direction constitutes a vertically upward direction. However, in the following description, there are cases where the Z-axis direction is described as being a direction that is different from (intersects) a vertical direction.

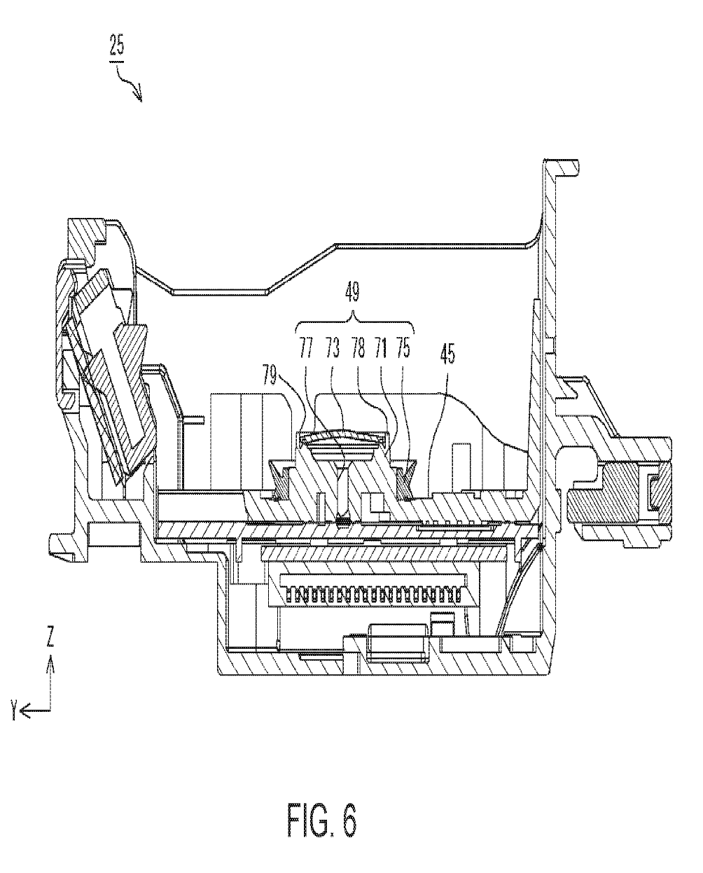

As shown in FIG. 6, which is a cross-sectional view of the carriage unit 25, each ink introduction portion 49 is provided in the bottom portion 45 of the holder 31. It should be noted that FIG. 6 shows a cross section of the carriage unit 25 when cut along a YZ plane that passes through an ink introduction portion 49. The ink introduction portion 49 includes an ink introduction tube 71, a filter 73, and a seal member 75. The ink introduction tube 71 is provided in the bottom portion 45, and projects from the bottom portion 45 in such a manner as to protrude in the Z-axis direction. A flow passage 77 and a bank portion 78 are formed in the ink introduction tube 71. The flow passage 77 is a passage for ink supplied from the corresponding cartridge 5, and is provided as an opening that passes through the bottom portion 45.

The bank portion 78 is provided at an end portion of the ink introduction tube 71 with respect to the Z-axis direction, and projects therefrom in such a manner as to protrude in the Z-axis direction. In a plan view of the bottom portion 45, the bank portion 78 annularly surrounds the flow passage 77 inside the recess 43. Therefore, the bank portion 78 has a tubular shape. An opening 79 of the tubular bank portion 78 constitutes an ink receiving port from the cartridge 5 to the ink introduction portion 49. It should be noted that in a region inside the opening 79, which is the ink receiving port, a region where the ink can flow into the flow passage 77 via the filter 73 is defined as a liquid introduction port. The liquid introduction port is that portion of the ink introduction portion 49 through which a liquid can pass. That is to say, the liquid introduction port is an effective area that contributes to the ink supply amount, of the filter 73.

In the present embodiment, the direction in which the tubular bank portion 78 projects, that is, the direction in which the flow passage 77 extends is the Z-axis direction. That is to say, the central axis of the flow passage 77 extends along the Z-axis. The filter 73 is provided inside the bank portion 78 and covers an opening of the flow passage 77 on the recess 43 side from the recess 43 side. The seal member 75 is provided on the bottom portion 45, and surrounds the bank portion 78 inside the recess 43. Therefore, the above-described liquid introduction port is surrounded by the seal member 75. The seal member 75 may be composed of an elastic material such as rubber or an elastomer, for example.

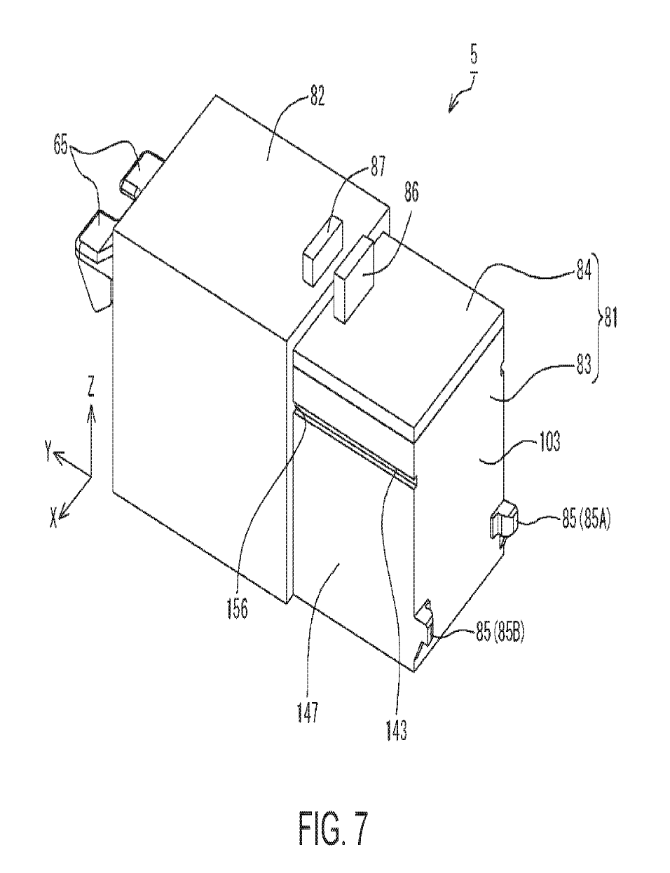

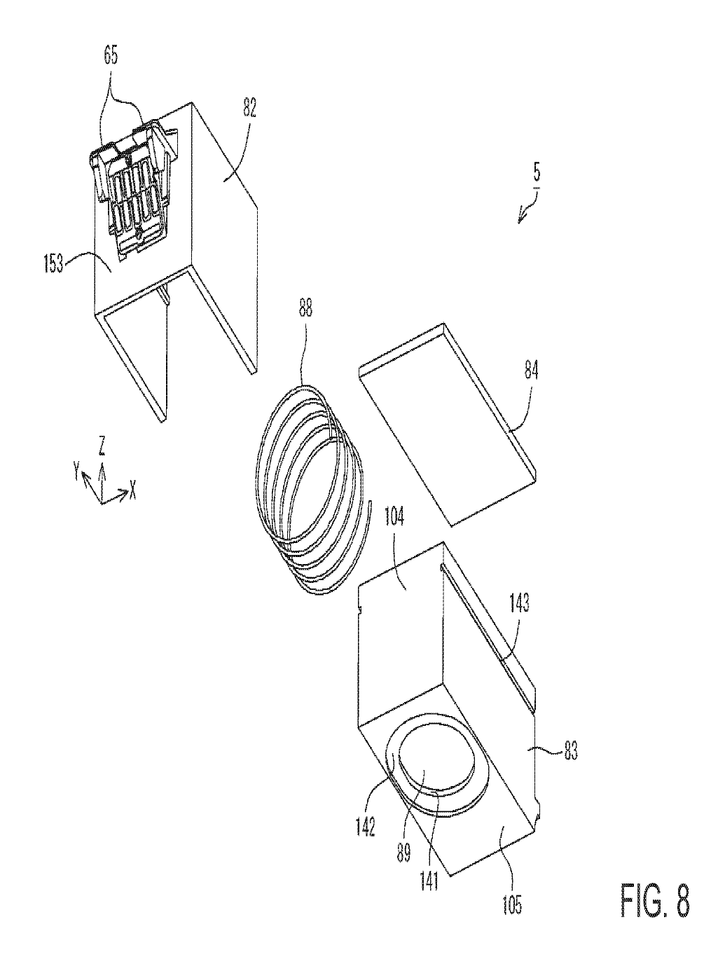

The following is a description of the cartridges 5. As shown in FIG. 7, each cartridge 5 has a first housing 81 and a second housing 82. The first housing 81 has a container case 83 and a lid case 84. The container case 83 is provided with two engagement protrusions 85. The lid case 84 is provided with a first operating portion 86. The first operating portion 86 is located on the Z-axis direction side of the lid case 84. The first operating portion 86 projects from the lid case 84 in the Z-axis direction. The second housing 82 is provided on the Y-axis direction side of the first housing 81. The second housing 82 is provided with a second operating portion 87. The second operating portion 87 is located on the Z-axis direction side of the second housing 82. The second operating portion 87 projects from the second housing 82 in the Z-axis direction. The first operating portion 86 and the second operating portion 87 oppose each other along the Y-axis. Moreover, as shown in FIG. 8, the cartridge 5 has a biasing member 88 and an ink holding member 89.

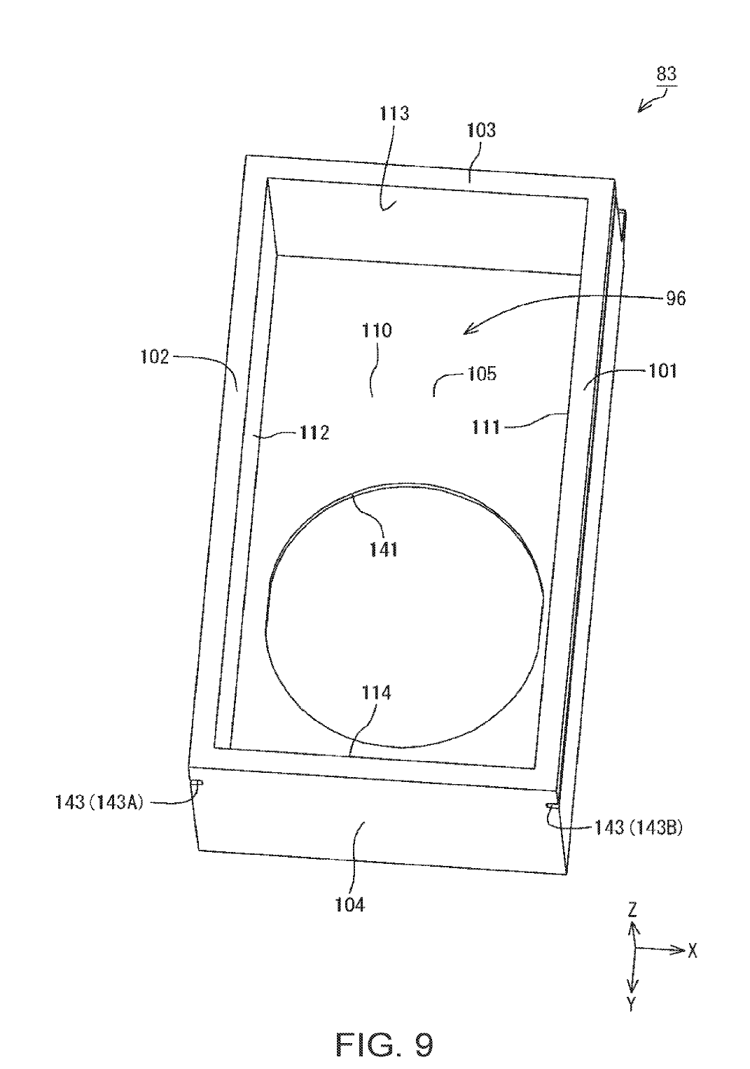

As shown in FIG. 9, the container case 83 has a vessel-like shape and has a recess 96. The container case 83 has a partition wall 101, a partition wall 102, a partition wall 103, a partition wall 104, and a partition wall 105. The partition wall 105 extends along an XY plane. The partition walls 101 to 104 each project from the partition wall 105 in the Z-axis direction. It should be noted that the partition walls 101 to 104 are not necessarily required to be orthogonal to the partition wall 105, and it is sufficient if those partition walls intersect the partition wall 105. Moreover, in a plan view of the partition wall 105 when viewed in the −Z-axis direction, the partition walls 101 to 104 surround the partition wall 105. In a plan view of the partition wall 105 when viewed in the −Z-axis direction, the partition walls 101 and 102 individually extend along the Y-axis. In a plan view of the partition wall 105 when viewed in the −Z-axis direction, the partition walls 103 and 104 extend along the X-axis.

The partition wall 101 and the partition wall 102 oppose each other along the X-axis across the partition wall 105. The partition wall 101 is located on the X-axis direction side relative to the partition wall 102. The partition walls 103 and 104 oppose each other along the Y-axis across the partition wall 105. The partition wall 104 is located on the Y-axis direction side relative to the partition wall 103. The partition wall 103 intersects the partition wall 101 and the partition wall 102. The partition wall 104 also intersects the partition wall 101 and the partition wall 102. Due to the above-described configuration, the recess 96 is formed in the container case 83.

In the container case 83 shown in FIG. 9, the recess 96 is demarcated by a bottom wall 110, a first side wall 111, a second side wall 112, a third side wall 113, and a fourth side wall 114. The first to fourth side walls 111 to 114 individually constitute inner walls of the recess 96 and project from the bottom wall 110 in the Z-axis direction. It should be noted that the first to fourth side walls 111 to 114 are not necessarily required to be orthogonal to the bottom wall 110, and it is sufficient if those side walls intersect the bottom wall 110. Moreover, in a plan view of the bottom wall 110 when viewed in the −Z-axis direction, the first to fourth side walls 111 to 114 surround the bottom wall 110. Thus, the recess 96 is demarcated. In a plan view of the bottom wall 110, the first side wall 111 and the second side wall 112 individually extend along the Y-axis. Similarly, the third side wall 113 and the fourth side wall 114 extend along the X-axis.

The bottom wall 110 is a portion of the partition wall 105 and constitutes a wall surface in the recess 96. The first side wall 111 is a portion of the partition wall 101 and constitutes a wall surface in the recess 96. The second side wall 112 is a portion of the partition wall 102 and constitutes a wall surface in the recess 96. The third side wall 113 is a portion of the partition wall 103 and constitutes a wall surface in the recess 96. The fourth side wall 114 is a portion of the partition wall 104 and constitutes a wall surface in the recess 96. It should be noted that the bottom wall 110 and the first to fourth side walls 111 to 114 are not limited to flat surfaces and may have unevenness or may contain a curved surface. Also, surfaces of the partition walls 101 to 105 on the outside of the recess 96 are not limited to flat surfaces, and may have unevenness or may contain a curved surface.

An ink supply hole 141 is formed in the partition wall 105. The ink supply hole 141 passes through the partition wall 105. The ink supply hole 141 formed in the partition wall 105 passes therethrough such that the inside of the recess 96 and the outside of the container case 83 communicate with each other. Ink that is contained in the recess 96 is discharged to the outside of the cartridge 5 from the ink supply hole 141. Moreover, as shown in FIG. 8, the partition wall 105 of the container case 83 is provided with a reference surface 142 that surrounds the ink supply hole 141. The reference surface 142 is a surface that the seal member 75 abuts against when the cartridge 5 is attached to the holder 31.

As shown in FIG. 8, the ink supply hole 141 is covered by the ink holding member 89. The ink holding member 89 is contained in the recess 96 (FIG. 9) of the container case 83 and covers the ink supply hole 141 of the container case 83 from the inside of the recess 96. The ink holding member 89 has the properties of absorbing ink and holding the absorbed ink. For example, various materials such as foam, felt, nonwoven fabric, and the like can be used as the material for the ink holding member 89. In the present embodiment, nonwoven fabric is used as the material for the ink holding member 89.

Ink is contained in the recess 96 of the container case 83. In the recess 96, the ink is contained in a state in which it is absorbed by the ink holding member 89. The lid case 84 is joined to the container case 83 as shown in FIG. 7. As shown in FIG. 8, the lid case 84 is provided on the Z-axis direction side of the container case 83. The lid case 84 closes the recess 96 of the container case 83 from the Z-axis direction side of the container case 83. It should be noted that in the present embodiment, the lid case 84 is joined to the container case 83 by fusion bonding. As described above, the ink is contained in the recess 96 of the container case 83 in a state in which the lid case 84 is joined to the container case 83. Therefore, the first housing 81 shown in FIG. 7 has the function of an ink containing portion 147 that contains ink.

As shown in FIG. 7, the two engagement protrusions 85 of the container case 83 are provided on the partition wall 103 of the container case 83. The two engagement protrusions 85 project from the partition wall 103 in the −Y-axis direction. The two engagement protrusions 85 are lined up along the X-axis while being spaced apart from each other. Hereinafter, in the case where the two engagement protrusions 85 are to be distinguished from each other, the two engagement protrusions 85 will be referred to as an engagement protrusion 85A and an engagement protrusion 85B, respectively. The engagement protrusion 85A is located on the −X-axis direction side relative to the engagement protrusion 85B.

Moreover, two guide grooves 143 are formed in the container case 83. In the container case 83, the guide grooves 143 are formed in the partition wall 101 and the partition wall 102 (FIG. 9), respectively. The two guide grooves 143 are individually formed along the Y-axis. Hereinafter, in the case where the two guide grooves 143 are to be distinguished from each other, the two guide grooves 143 will be referred to as a guide groove 143A and a guide groove 143B, respectively. The guide groove 143A is formed in the partition wall 102, and is formed in such a manner as to be recessed from the outside of the recess 96 toward the partition wall 101. The guide groove 143B is formed in the partition wall 101, and is formed in such a manner as to be recessed from the outside of the recess 96 toward the partition wall 102. As shown in FIG. 8, the two guide grooves 143 are formed in positions that are nearer to the lid case 84 than to the partition wall 105. It should be noted that the guide grooves 143 are an example of a first guide portion.

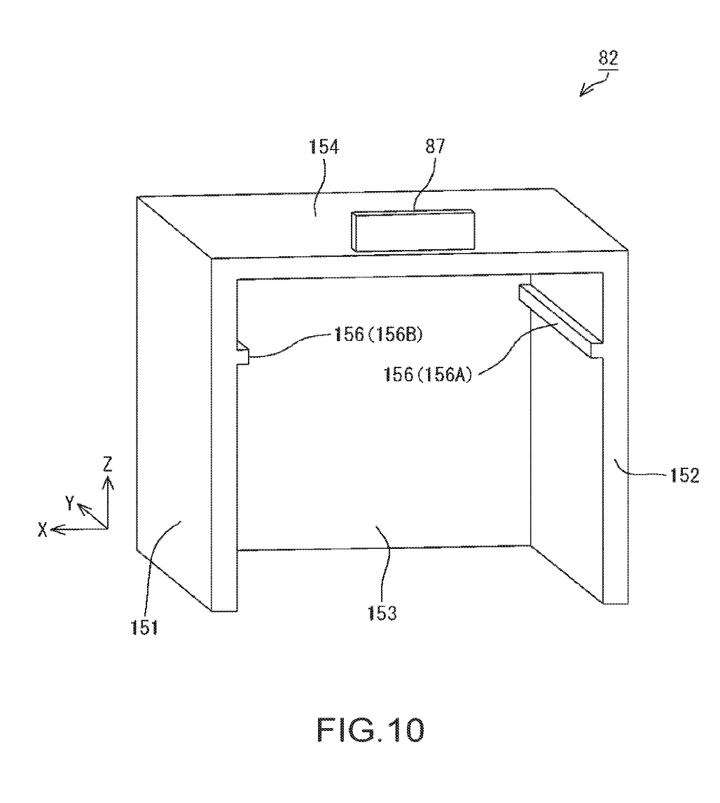

As shown in FIG. 10, the second housing 82 has a partition wall 151, a partition wall 152, a partition wall 153, and a partition wall 154. The partition wall 151 and the partition wall 152 individually extend along a YZ plane. The partition wall 151 and the partition wall 152 oppose each other along the X-axis. The partition wall 151 is located on the X-axis direction side relative to the partition wall 152. The partition wall 151 and the partition wall 152 are spaced apart from each other. The partition wall 153 extends along an XZ plane. The partition wall 153 intersects the partition wall 151 and the partition wall 152. The partition wall 153 is located on the Y-axis direction side of the partition wall 151 and the partition wall 152. The partition wall 154 extends along an XY plane. The partition wall 154 intersects the partition wall 151, the partition wall 152, and the partition wall 153. The partition wall 154 is located on the Z-axis direction side of the partition wall 151, the partition wall 152, and the partition wall 153. It should be noted that the aforementioned second operating portion 87 is provided on the partition wall 154. The second operating portion 87 projects from the partition wall 154 in the Z-axis direction. Moreover, as shown in FIG. 8, the aforementioned engagement portions 65 are provided on the partition wall 153. The engagement portions 65 project from the partition wall 153 in the Y-axis direction.

As shown in FIG. 10, guided portions 156 are formed on the partition wall 151 and the partition wall 152, respectively. The guided portions 156 are an example of a second guide portion. Hereinafter, in the case where the two guided portions 156 are to be distinguished from each other, the two guided portions 156 will be referred to as a guided portion 156A and a guided portion 156B, respectively. The guided portion 156A is formed at a position on the partition wall 152 that faces the partition wall 151, and is formed in such a manner as to protrude from the partition wall 152 toward the partition wall 151. The guided portion 156B is formed at a position on the partition wall 151 that faces the partition wall 152, and is formed in such a manner as to protrude from the partition wall 151 toward the partition wall 152.

The distance between the partition wall 151 and the partition wall 152 along the X-axis is greater than the width of the container case 83 (FIG. 9) along the X-axis. In addition, the two guided portions 156 are configured to be engageable with the two guide grooves 143 of the container case 83. With the above-described configuration, as shown in FIG. 7, in a state in which the two guided portions 156 are in engagement with the two guide grooves 143 of the container case 83, the first housing 81 can be inserted into the second housing 82. It should be noted that as shown in FIG. 8, the aforementioned engagement portions 65 are provided on the partition wall 153 of the second housing 82. The engagement portions 65 project from the partition wall 153 in the Y-axis direction.

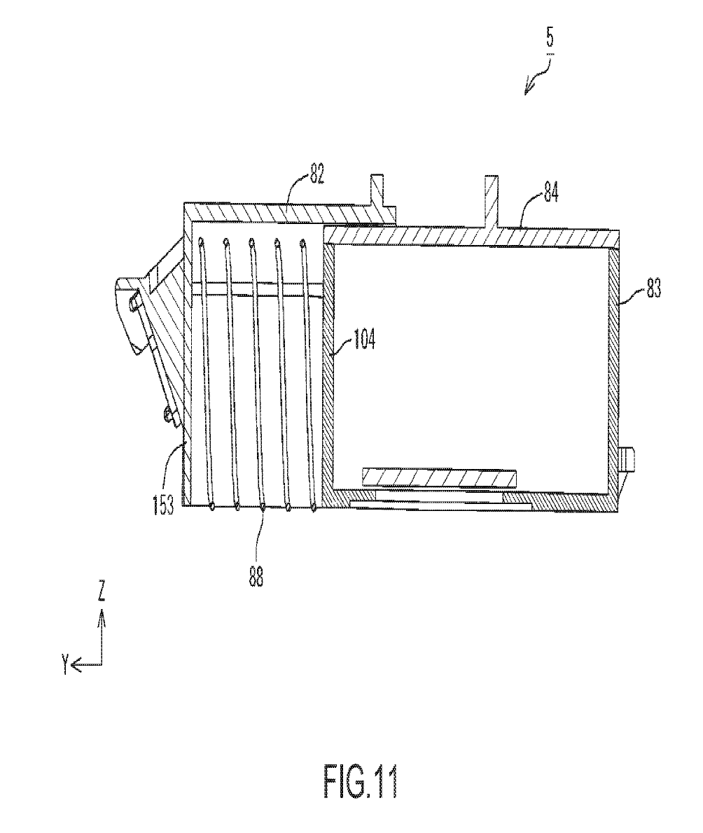

As shown in FIG. 8, the biasing member 88 is provided between the container case 83 and the second housing 82. As shown in FIG. 11, which is a cross-sectional view of the cartridge 5, the biasing member 88 is held between the partition wall 104 of the container case 83 and the partition wall 153 of the second housing 82. FIG. 11 shows a cross-sectional view of the cartridge 5 when cut along a YZ plane. The biasing member 88 produces a biasing force in a direction in which the container case 83 and the second housing 82 are moved away from each other. It should be noted that in the present embodiment, the biasing member 88 is composed of a compression coil spring. However, the configuration of the biasing member 88 is not limited to this, and various types of springs or elastic materials such as rubber or an elastomer can be used.

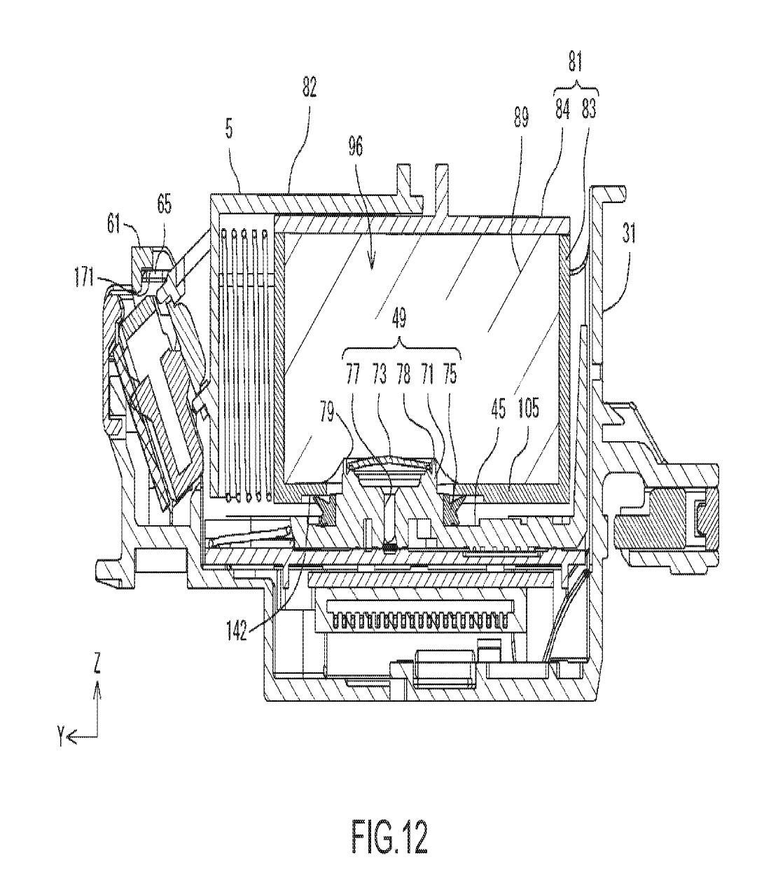

When the cartridge 5 is attached to the holder 31, as shown in FIG. 12, the seal member 75 abuts against the reference surface 142 of the cartridge 5. At this time, the seal member 75 abuts against the reference surface 142 in a state in which the seal member 75 is bent. The seal member 75 abuts against the reference surface 142 in a state in which the seal member 75 surrounds the circumference of the ink supply hole 141 from the outside of the ink supply hole 141. Thus, during supply of the ink from the cartridge 5 to the flow passage 77, the ink spilling to the outside of the region surrounded by the bank portion 78 can be blocked by the seal member 75. Thus, in a state in which the cartridge 5 is attached to the holder 31, leakage of the ink in the cartridge 5 to the holder 31 can be easily avoided. When the cartridge 5 is attached to the holder 31, the bank portion 78 abuts against the ink holding member 89. In the present embodiment, a configuration is adopted in which when the cartridge 5 is attached to the holder 31, the bank portion 78 presses the ink holding member 89 toward the inner side of the recess 96 of the cartridge 5. Thus, the state in which the ink holding member 89 and the filter 73 abut against each other can be easily maintained.

Here, a region of the ink holding member 89 that is exposed to the outside of the cartridge 5 via the ink supply hole 141 (FIG. 8) is defined as an ink supply port. The ink supply port is an example of a liquid supply port. Moreover, when the cartridge 5 is attached to the holder 31, a region of the ink introduction portion 49 that is surrounded by the seal member 75 is defined as an ink supply portion. The ink supply portion is an example of a liquid supply portion. The ink in the cartridge 5 is supplied to the flow passage 77 (FIG. 12) of the holder 31 via the ink supply portion.

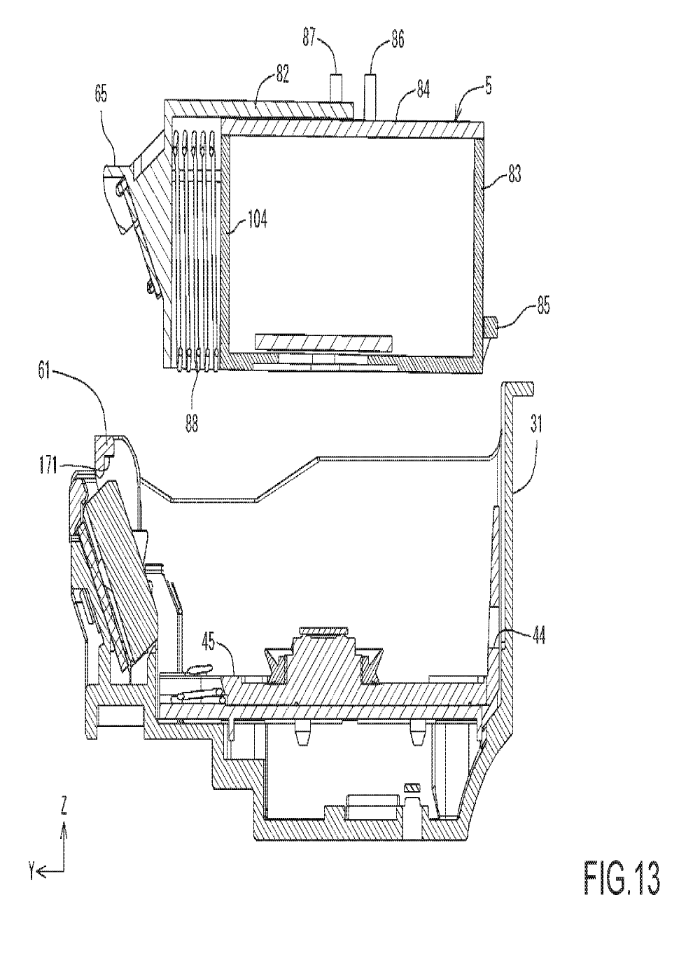

A method (attachment method) for attaching the cartridge 5 to the holder 31 will be described. In the attachment method according to the present embodiment, first, as shown in FIG. 13, the overall length of the cartridge 5 along the Y-axis is compressed from the state shown in FIG. 12. This is achieved by bending (compressing) the biasing member 88. At this time, the overall length of the cartridge 5 can be compressed by pinching the first operating portion 86 and the second operating portion 87 of the cartridge 5 between the fingers along the Y-axis. At this time, the overall length of the cartridge 5 can be compressed by holding the first operating portion 86 and the second operating portion 87 together from both sides such that these two portions are brought nearer to each other along the Y-axis. At this time, the engagement of the guided portions 156 (FIG. 7) of the second housing 82 with the guide grooves 143 of the container case 83 allows the first housing 81 and the second housing 82 to be displaced in a direction in which these two housings are moved toward each other along the Y-axis.

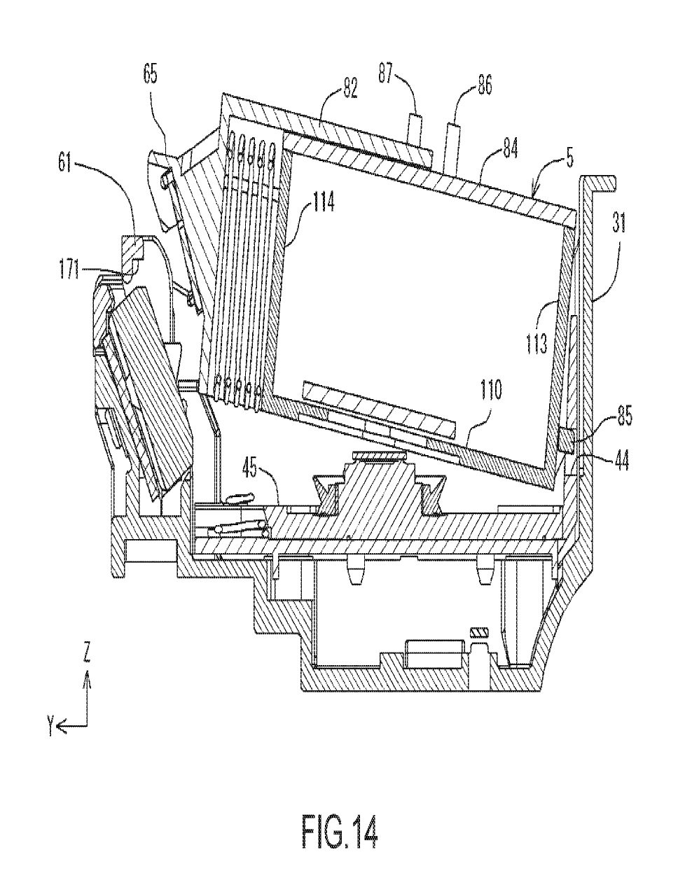

Next, as shown in FIG. 14, in a state in which the cartridge 5 is inclined with respect to the holder 31, the cartridge 5 is inserted into the holder 31. At this time, the bottom wall 110 of the cartridge 5 is inclined with respect to the bottom portion 45 of the holder 31. At this time, the bottom wall 110 is inclined in such a direction that the distance from the bottom portion 45 decreases from the fourth side wall 114 side toward the third side wall 113 side, that is, toward the −Y-axis direction side. Then, in a state in which the cartridge 5 is inclined with respect to the holder 31, the engagement protrusions 85 are inserted into the corresponding engagement holes 44 while bringing the cartridge 5 nearer to the bottom portion 45. It should be noted that FIG. 14 shows a state in which the engagement portions 65 of the cartridge 5 are located on the Z-axis direction side relative to an engagement portion 171 of the engaged portion 61 of the holder 31.

Next, from the state shown in FIG. 14, the cartridge 5 is rotated (pivoted) about the engagement protrusions 85 inserted in the corresponding engagement holes 44, the engagement protrusions 85 serving as pivot points, in a direction in which the engagement portions 65 are brought nearer to the bottom portion 45, that is, in such a manner that the fourth side wall 114 side is pushed into the recess 43 of the holder 31. Then, the engagement portions 65 are displaced to the −Z-axis direction side relative to the engagement portion 171 of the engaged portion 61. At this time, releasing the compression of the biasing member 88 causes the engagement portions 65 to engage with the engagement portion 171 of the engaged portion 61 as shown in FIG. 12. Attachment of the cartridge 5 to the holder 31 is completed by the engagement portions 65 engaging with the engagement portion 171 of the engaged portion 61. At this time, the first housing 81 and the second housing 82 are biased by the biasing member 88 in a direction away from each other, and thus the position of the cartridge 5 with respect to the Y-axis direction is restricted. It should be noted that in the present embodiment, the engagement holes 44 correspond to a first engaged portion, the engaged portion 61 corresponds to a second engaged portion, the engagement protrusions 85 correspond to a first engagement portion, the engagement portions 65 correspond to a second engagement portion, and the biasing member 88 corresponds to a biasing portion.

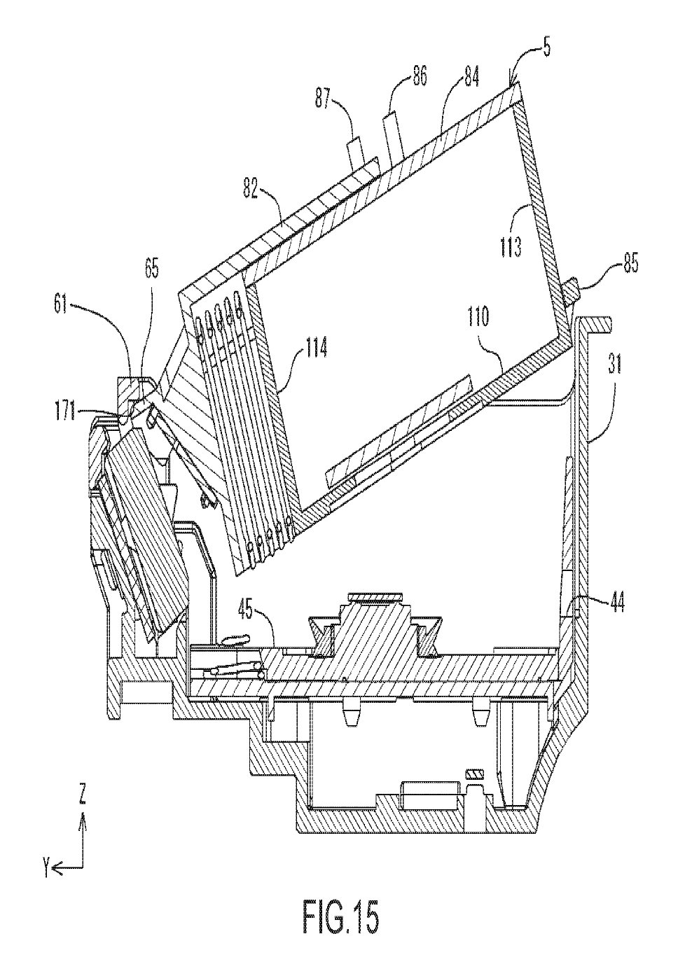

It should be noted that with respect to the above-described attachment method, a method is adopted in which, as shown in FIG. 14, the engagement protrusions 85 are inserted into the corresponding engagement holes 44 in a state in which the bottom wall 110 of the cartridge 5 is inclined in such a direction that the distance from the bottom portion 45 decreases toward the −Y-axis direction side. However, the attachment method is not limited to this. With respect to the attachment method, a method may also be adopted in which, as shown in FIG. 15, the engagement portions 65 are inserted into the engaged portion 61 in a state in which the bottom wall 110 of the cartridge 5 is inclined in such a direction that the distance from the bottom portion 45 decreases toward the Y-axis direction side. In this method, attachment of the cartridge 5 to the holder 31 is completed by rotating (pivoting) the cartridge 5 about the engagement portions 65 inserted in the engaged portion 61, the engagement portions 65 serving as pivot points, in a direction in which the engagement protrusions 85 are brought nearer to the engagement holes 44.

In the present embodiment, the state in which the engagement portions 65 engage with the engaged portion 61 and the state in which the engagement protrusions 85 engage with the corresponding engagement holes 44 as well as the state in which the contact mechanism 62 and the terminal portion 66 are in electrical contact with each other can be achieved by the biasing member 88 biasing the second housing 82 in a direction away from the first housing 81. Moreover, the state in which the engagement portions 65 engage with the engaged portion 61 and the state in which the engagement protrusions 85 engage with the corresponding engagement holes 44 as well as the state in which the contact mechanism 62 and the terminal portion 66 are in electrical contact with each other can be released by displacing the second housing 82 in a direction toward the first housing 81. Thus, it is possible to attach/remove the cartridge 5 to/from the printer 3 using a novel engagement mechanism that has not been proposed by related art. Therefore, levers can be omitted from the cartridge 5 and the carriage unit 25, so that the sizes of the cartridge 5 and the carriage unit 25 and hence the size of the printer 3 can be easily reduced.

Moreover, in the present embodiment, in a state in which the cartridge 5 is attached to the printer 3, the engagement portions 65 abut against the engaged portion 61 in the Z-axis direction, which is a direction that intersects a direction along the reference surface 142. Moreover, in the state in which the cartridge 5 is attached to the printer 3, the engagement protrusions 85 abut against the corresponding engagement holes 44 in the Z-axis direction, which is the direction that intersects the direction along the reference surface 142. This configuration eliminates the necessity for a lever structure provided in either the cartridge 5 or the printer 3.

Moreover, in the present embodiment, the first housing 81 has the first operating portion 86. The first operating portion 86 is used to elastically deform (compress) the biasing member 88 and change the position of the first housing 81 relative to the second housing 82. In the state in which the cartridge 5 is attached to the printer 3, this first operating portion 86 is located on a side of the recess 96 of the container case 83 that is opposite to the ink supply hole 141 with respect to the Z-axis direction, which is the direction that intersects the direction along the reference surface 142. This configuration makes it possible to readily release the state in which the engagement portions 65 engage with the engaged portion 61 and the state in which the engagement protrusions 85 engage with the corresponding engagement holes 44 as well as the state in which the contact mechanism 62 and the terminal portion 66 are in electrical contact with each other.

Moreover, in the present embodiment, the second housing 82 has the second operating portion 87. The second operating portion 87 is used to elastically deform (compress) the biasing member 88 and change the position of the second housing 82 relative to the first housing 81. In the state in which the cartridge 5 is attached to the printer 3, this second operating portion 87 is located on a side of the recess 96 of the container case 83 that is opposite side to the ink supply hole 141 with respect to the Z-axis direction, which is the direction that intersects the direction along the reference surface 142. This configuration makes it possible to readily release the state in which the engagement portions 65 engage with the engaged portion 61 and the state in which the engagement protrusions 85 engage with the corresponding engagement holes 44 as well as the state in which the contact mechanism 62 and the terminal portion 66 are in electrical contact with each other.

Moreover, in the present embodiment, in the state in which the cartridge 5 is attached to the printer 3, the first operating portion 86 and the second operating portion 87 are provided on the same surface of outer surfaces of the cartridge 5. This configuration makes it possible to readily release the state in which the engagement portions 65 engage with the engaged portion 61 and the state in which the engagement protrusions 85 engage with the corresponding engagement holes 44 as well as the state in which the contact mechanism 62 and the terminal portion 66 are in electrical contact with each other. It should be noted that the same surface refers to a surface that faces in the same direction and does not only mean a perfectly flush surface, and so the same surface also includes a surface containing an error or a tolerance, a surface having unevenness, a surface containing a step, and the like.

Moreover, in the present embodiment, in the state in which the cartridge 5 is attached to the printer 3, at least a portion of the first operating portion 86 and at least a portion of the second operating portion 87 have equal heights from the reference surface 142 in the Z-axis direction, which is the direction that intersects the direction along the reference surface 142. This configuration makes it possible to readily release the state in which the engagement portions 65 engage with the engaged portion 61 and the state in which the engagement protrusions 85 engage with the corresponding engagement holes 44 as well as the state in which the contact mechanism 62 and the terminal portion 66 are in electrical contact with each other. It should be noted that “equal” does not only mean perfect equality and is a concept including errors and tolerances.

Moreover, in the present embodiment, in the state in which the cartridge 5 is attached to the printer 3, the guide grooves 143 are provided in the side walls of the first housing 81 that extend in the Z-axis direction, which is the direction that intersects the direction along the reference surface 142, and the guided portions 156 that can come into contact with the corresponding guide grooves 143 are provided on the side walls of the second housing 82 that extend in the Z-axis direction, which is the direction that intersects the direction along the reference surface 142. With this configuration, the position of the first housing 81 relative to the second housing 82 can be stabilized by the guide grooves 143 and the guided portions 156 coming into contact with each other. It should be noted that the relationship between the recessed guide grooves 143 and the protruding guided portions 156 may be reversed.

### Second Embodiment

With respect to the cartridges 5 of the above-described first embodiment, a configuration in which ink is contained in the first housing 81 is adopted. However, the configuration of the cartridges 5 is not limited to this. A configuration in which ink is contained in the second housing 82 may also be adopted as the configuration of the cartridges 5. The configuration of the cartridges 5 in which ink is contained in the second housing 82 will be described as a second embodiment below. It should be noted that components of the second embodiment that are similar to those of the first embodiment are denoted by the same reference numerals as those of the first embodiment, and a detailed description thereof is omitted.

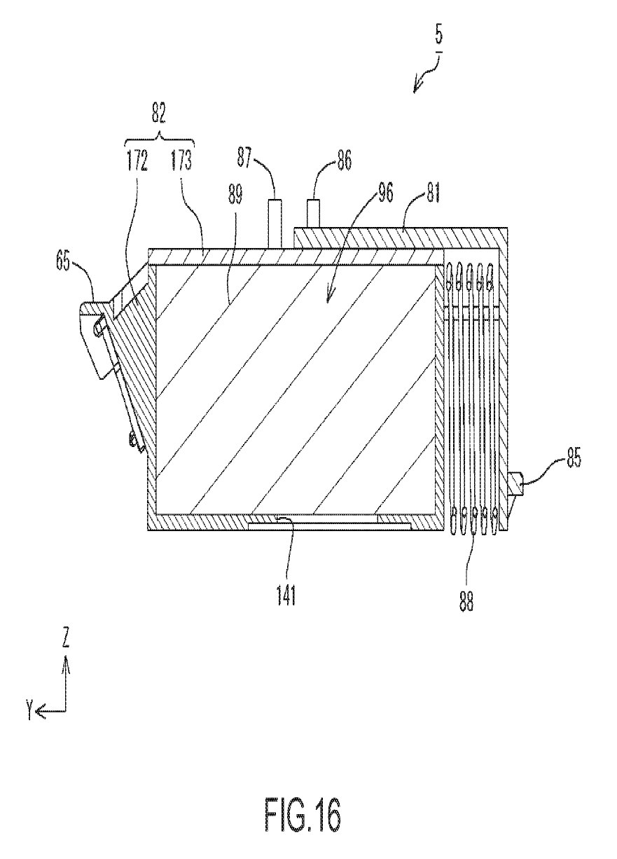

As shown in FIG. 16, in the cartridge 5 according to the second embodiment, the second housing 82 has a container case 172 and a lid case 173. The container case 172 has the engagement portions 65 and the recess 96. Moreover, the ink supply hole 141 is formed in the container case 172. The ink holding member 89 is contained in the recess 96 of the container case 172. Also, the recess 96 of the container case 172 is closed by the lid case 173. The second operating portion 87 is formed on the lid case 173.

The first housing 81 is located on the −Y-axis direction side of the second housing 82. The engagement protrusions 85 are provided at an end portion of the first housing 81 with respect to the −Y-axis direction. The biasing member 88 is located on the −Y-axis direction side of the second housing 82. The biasing member 88 is located between the container case 172 of the second housing 82 and the first housing 81. The biasing member 88 is held between the container case 172 of the second housing 82 and the first housing 81. The method for attaching the cartridge 5 of the second embodiment is similar to that of the first embodiment, and a detailed description thereof is omitted. The second embodiment has similar effects to those of the first embodiment.

### Third Embodiment

The holder 31 and the cartridge 5 according to a third embodiment will be described. Those components of the holder 31 and the cartridge 5 according to the third embodiment that have similar functions to those of the first embodiment are denoted by the same reference numerals as those of the first embodiment, and a detailed description thereof is omitted.

As shown in FIG. 17, the holder 31 of the third embodiment has the recess 43. The cartridge 5 is attached inside the recess 43 of the holder 31. According to the present embodiment, six cartridges 5 can be attached inside the recess 43. According to the present embodiment, the six cartridges 5 that are attached inside the recess 43 are contained in the recess 43 while being spaced apart from each other. The ink introduction portions 49 respectively corresponding to the six cartridges 5 that are attached inside the recess 43 are provided in the recess 43. That is to say, according to the present embodiment, six ink introduction portions 49 are provided in the holder 31. The six ink introduction portions 49 are lined up along the X-axis in the recess 43. Then, the six cartridges 5 attached to the holder 31 are lined up along the X-axis in the recess 43. It should be noted that FIG. 17 shows a state in which one cartridge 5 is attached to the holder 31.

Moreover, six engaged portions 61 and six engagement holes 44 are provided in the holder 31. In the present embodiment, for each of the attachment positions of the cartridges 5, one engaged portion 61 and one engagement hole 44 are provided. The six engaged portions 61 are lined up along the X-axis. The six engagement holes 44 are also lined up along the X-axis.

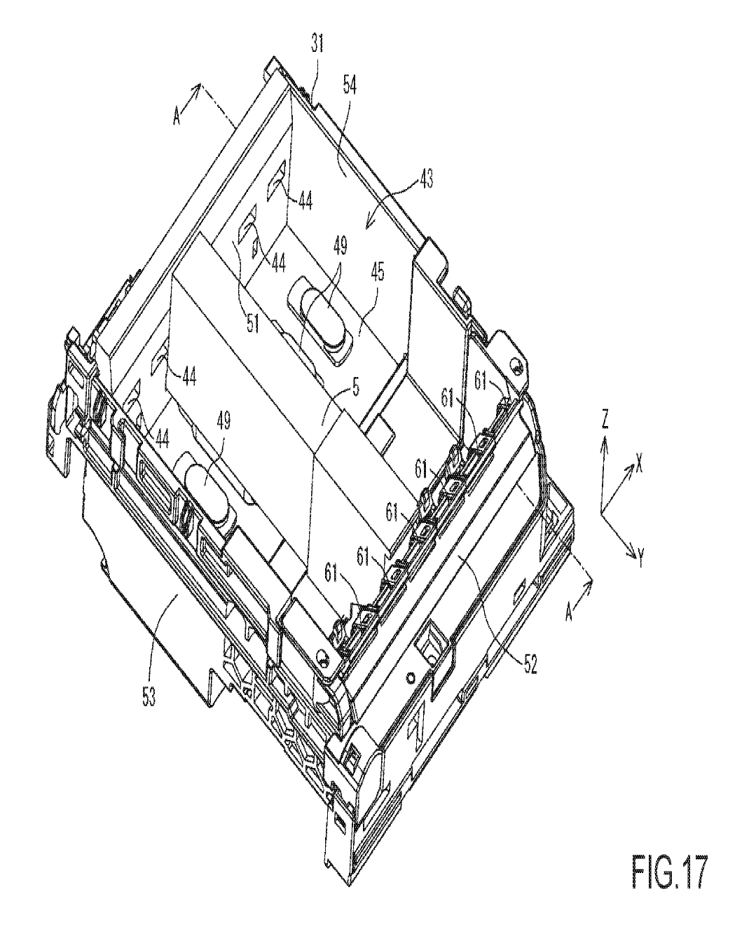

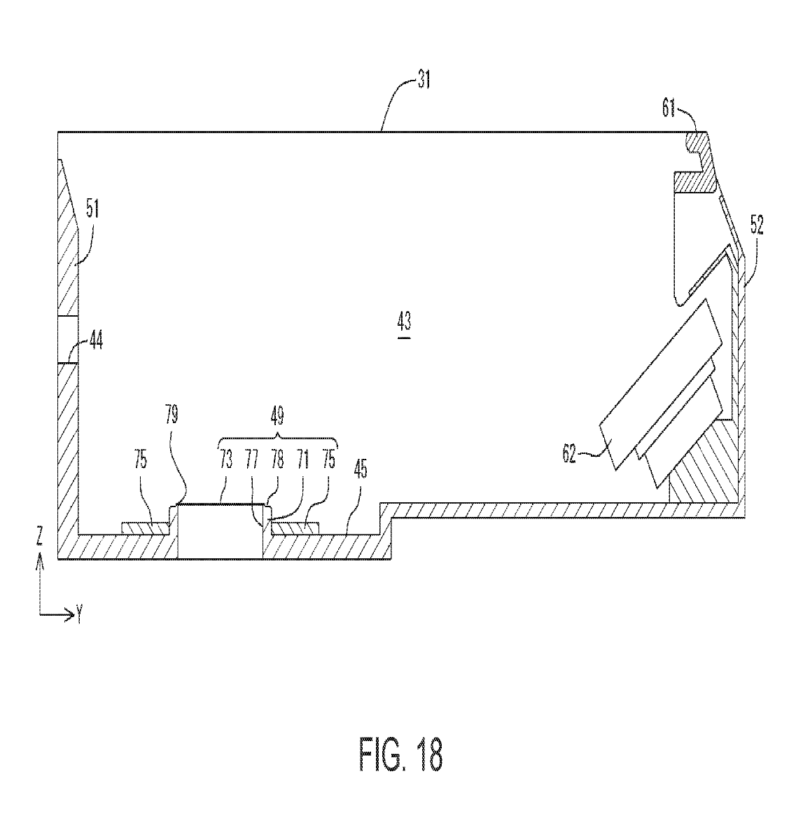

As shown in FIG. 18, which is a cross-sectional view taken along line A-A in FIG. 17, the engaged portions 61 are provided between the side wall 52 and the side wall 51. It should be noted that FIG. 18 corresponds to a cross-sectional view of the holder 31 when cut along a YZ plane that passes through an ink introduction portion 49. The engaged portions 61 are provided between the side wall 52 and the introduction portions 49. The engaged portions 61 fix the corresponding cartridges 5 attached to the holder 31. A worker can remove a cartridge 5 from the holder 31 by releasing the fixation of that cartridge 5 by the corresponding engaged portion 61. The engagement holes 44 are provided in the side wall 51. The engagement holes 44 pass through the side wall 51.

The ink introduction portions 49 are provided in the bottom portion 45 between the corresponding engaged portions 61 and the side wall 51. Each ink introduction portion 49 includes the ink introduction tube 71, the filter 73, and the seal member 75. The ink introduction tube 71 is provided in the bottom portion 45 and projects from the bottom portion 45 in such a manner as to protrude in the Z-axis direction. The flow passage 77 and the bank portion 78 are formed in the ink introduction tube 71. The flow passage 77 is a passage for ink that is supplied from the corresponding cartridge 5, and is provided as an opening that passes through the bottom portion 45.

The bank portion 78 is provided at an end portion of the ink introduction tube 71 with respect to the Z-axis direction and projects therefrom in such a manner as to protrude in the Z-axis direction. In a plan view of the bottom portion 45, the bank portion 78 annularly surrounds the flow passage 77 inside the recess 43. Thus, the bank portion 78 has a tubular shape. The opening 79 of the tubular bank portion 78 constitutes the ink receiving port from the cartridge 5 to the ink introduction portion 49. It should be noted that in a region inside the opening 79, which is the ink receiving port, a region where ink can flow into the flow passage 77 via the filter 73 is defined as the liquid introduction port. The liquid introduction port is that portion of the ink introduction portion 49 through which a liquid can pass. That is to say, the liquid introduction port is an effective area that contributes to the ink supply amount, of the filter 73.

In the present embodiment, the direction in which the tubular bank portion 78 projects, that is, the direction in which the flow passage 77 extends is the Z-axis direction. That is to say, the central axis of the flow passage 77 extends along the Z-axis. The filter 73 is provided inside the bank portion 78, and covers the opening of the flow passage 77 on the recess 43 side from the recess 43 side. The seal member 75 is provided on the bottom portion 45, and surrounds the bank portion 78 inside the recess 43. Thus, the above-described liquid introduction port is surrounded by the seal member 75. The seal member 75 may be composed of an elastic material such as rubber or an elastomer, for example.

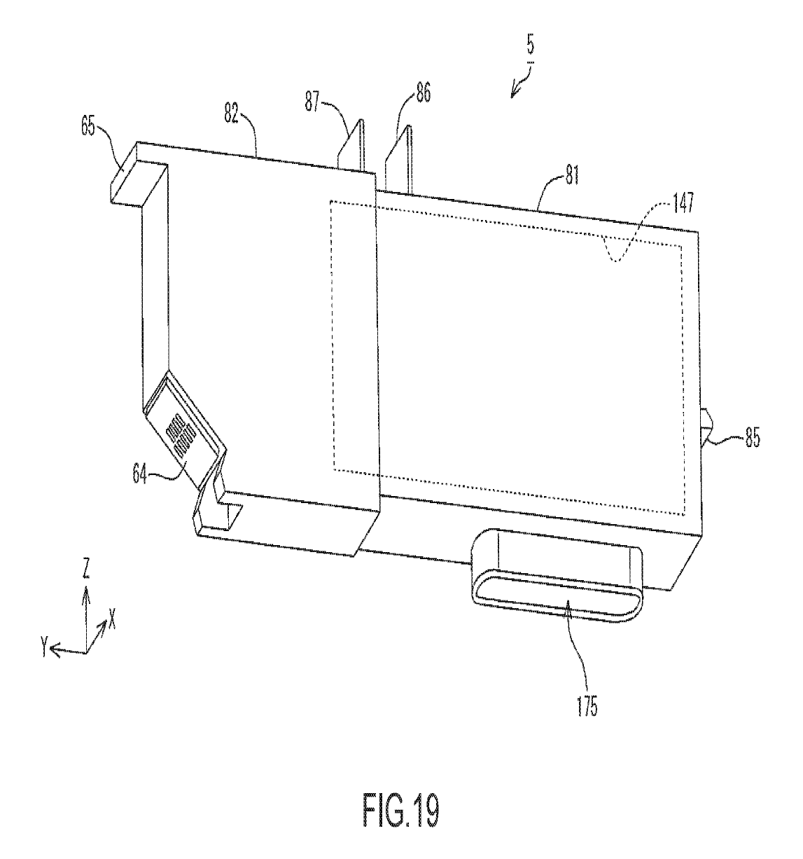

As shown in FIG. 19, the cartridge 5 has the first housing 81 and the second housing 82. The first housing 81 has the ink containing portion 147 and an ink supply portion 175. In the cartridge 5 according to the third embodiment, the configuration of the ink supply portion 175 and the shapes of the first housing 81 and the second housing 82 are different from those of the cartridge 5 of the first embodiment. Otherwise, the cartridge 5 of the third embodiment has a similar configuration to that of the cartridge 5 of the first embodiment. In the cartridge 5 of the third embodiment, components that have similar functions to those of the cartridge 5 of the first embodiment are denoted by the same reference numerals as those of the cartridge 5 of the first embodiment.

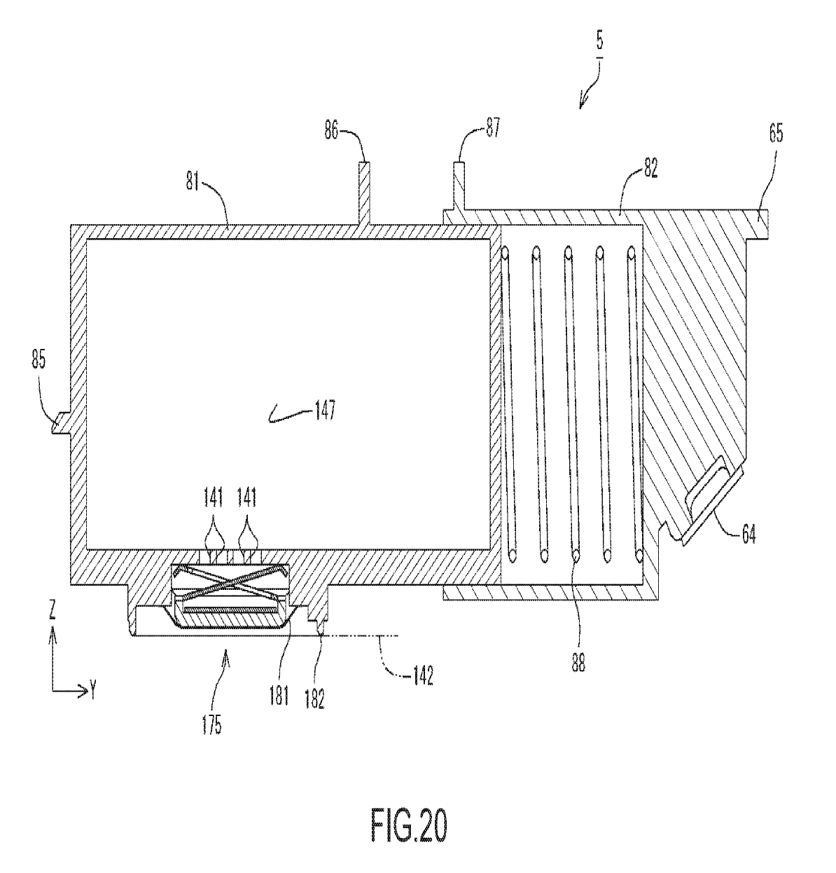

The first housing 81 is provided with the engagement protrusion 85 and the first operating portion 86. The second housing 82 is provided with the circuit board 64 and the engagement portion 65. Moreover, as shown in FIG. 20, which is a cross-sectional view of the cartridge 5, the biasing member 88 is held between the first housing 81 and the second housing 82. It should be noted that FIG. 20 shows a cross section of the cartridge 5 of the third embodiment when cut along a YZ plane. Ink supply holes 141 are formed in the first housing 81. The ink supply holes 141 each allow the outside of the first housing 81 and the inside of the ink containing portion 147 to communicate with each other. The ink supply holes 141 are covered by a filter 181 from the outside of the first housing 81. For example, a film material in which through holes are formed by press working, resin foam, woven fabric in which fibers, for example, are used, and the like can be used as the filter 181.

Moreover, a wall portion 182 that surrounds the ink supply holes 141 and the filter 181 is provided on the first housing 81. The wall portion 182 is provided at an end portion of the first housing 81 with respect to the −Z-axis direction and projects therefrom in the −Z-axis direction. In a state in which the cartridge 5 is attached to the holder 31, the wall portion 182 abuts against the seal member 75 of the corresponding ink introduction portion 49 (FIG. 18). In the present embodiment, in the state in which the cartridge 5 is attached to the printer 3, a surface where the wall portion 182 and the seal member 75 abut against each other is defined as the reference surface 142. That is to say, in the present embodiment, a surface passing through an end portion of the wall portion 182 of the cartridge 5 with respect to the −Z-axis direction is defined as the reference surface 142.

The wall portion 182 surrounds the ink supply holes 141 and the filter 181 from the outside of the ink containing portion 147. The ink supply portion 175 is a structure that includes the ink supply holes 141, the filter 181, and the wall portion 182. Moreover, a portion of the ink supply portion 175 through which ink can pass is defined as the ink supply port. The ink supply port may be, for example, an effective area that contributes to the ink supply amount, of the filter 181. In the cartridge 5 of the third embodiment, ink can be supplied from the ink supply portion 175 to the ink introduction portion 49 by the filter 181 abutting against the filter 73 of the ink introduction portion 49 (FIG. 18).

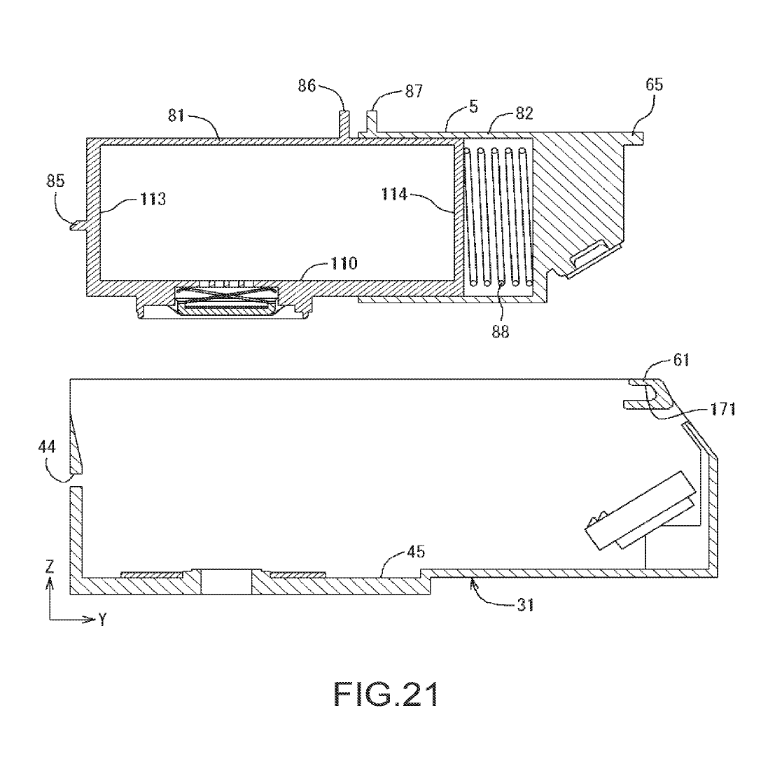

An attachment method according to the third embodiment will be described. In the attachment method according to the present embodiment, first, as shown in FIG. 21, the overall length of the cartridge 5 along the Y-axis is compressed from the state shown in FIG. 20. This is achieved by bending (compressing) the biasing member 88. At this time, the overall length of the cartridge 5 can be compressed by pinching the first operating portion 86 and the second operating portion 87 of the cartridge 5 between the fingers along the Y-axis. At this time, the overall length of the cartridge 5 can be compressed by holding the first operating portion 86 and the second operating portion 87 together from both sides such that these two operating portions are brought nearer to each other along the Y-axis. At this time, the engagement of the guided portions 156 (FIG. 7) of the second housing 82 with the corresponding guide grooves 143 of the container case 83 allows the first housing 81 and the second housing 82 to be displaced in a direction toward each other along the Y-axis. It should be noted that in the third embodiment as well, similarly to the first embodiment, the guide grooves 143 are formed in the first housing 81 and the guided portions 156 are formed on the second housing 82.

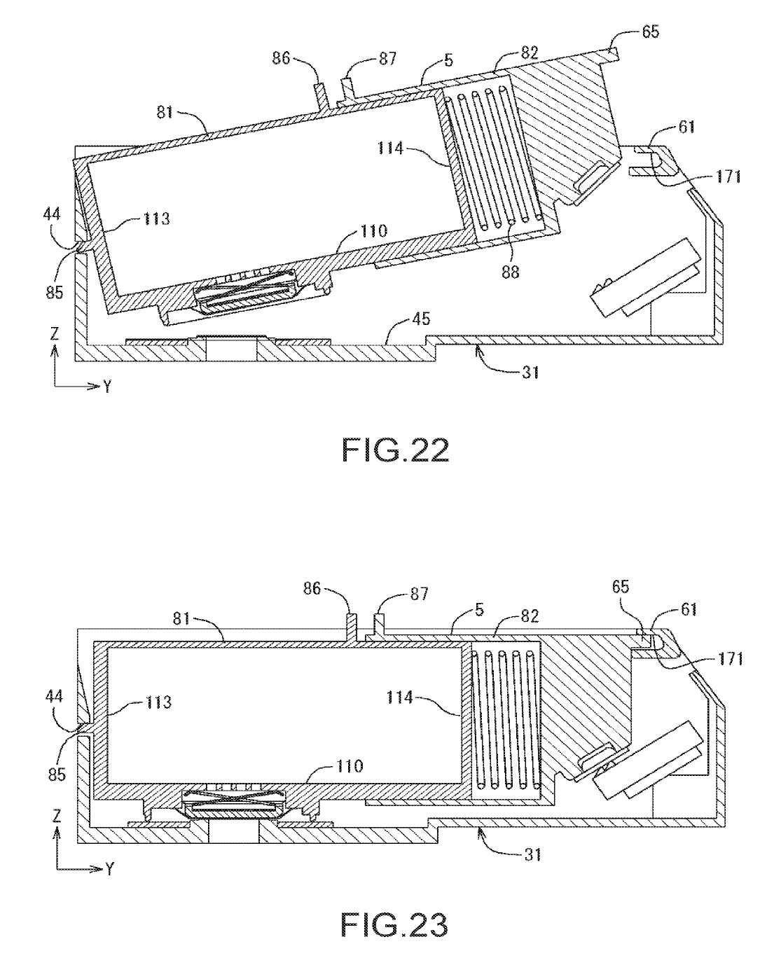

Next, as shown in FIG. 22, in a state in which the cartridge 5 is inclined with respect to the holder 31, the cartridge 5 is inserted into the holder 31. At this time, the bottom wall 110 of the cartridge 5 is inclined with respect to the bottom portion 45 of the holder 31. At this time, the bottom wall 110 is inclined in such a direction that the distance from the bottom portion 45 decreases from the fourth side wall 114 side toward the third side wall 113 side, that is, toward the −Y-axis direction side. Then, in a state in which the cartridge 5 is inclined with respect to the holder 31, the engagement protrusion 85 is inserted into the corresponding engagement hole 44 while bringing the cartridge 5 nearer to the bottom portion 45. It should be noted that FIG. 22 shows a state in which the engagement portion 65 of the cartridge 5 is located on the Z-axis direction side relative to the engagement portion 171 of the engaged portion 61 of the holder 31.

Next, from the state shown in FIG. 22, the cartridge 5 is rotated (pivoted) about the engagement protrusion 85 inserted in the engagement hole 44, the engagement protrusion 85 serving as a pivot point, in a direction in which the engagement portion 65 is brought nearer to the bottom portion 45, that is, in such a manner that the fourth side wall 114 side is pushed into the recess 43 of the holder 31. Then, the engagement portion 65 is displaced to the −Z-axis direction side relative to the engagement portion 171 of the engaged portion 61. At this time, releasing the compression of the biasing member 88 causes the engagement portion 65 to engage with the engagement portion 171 of the engaged portion 61 as shown in FIG. 23. Attachment of the cartridge 5 to the holder 31 is completed by the engagement portion 65 engaging with the engagement portion 171 of the engaged portion 61. At this time, the first housing 81 and the second housing 82 are biased by the biasing member 88 in a direction away from each other, and thus the position of the cartridge 5 with respect to the Y-axis direction is restricted. It should be noted that in the present embodiment, the engagement hole 44 corresponds to the first engaged portion, the engaged portion 61 corresponds to the second engaged portion, the engagement protrusion 85 corresponds to the first engagement portion, the engagement portion 65 corresponds to the second engagement portion, and the biasing member 88 corresponds to the biasing portion.

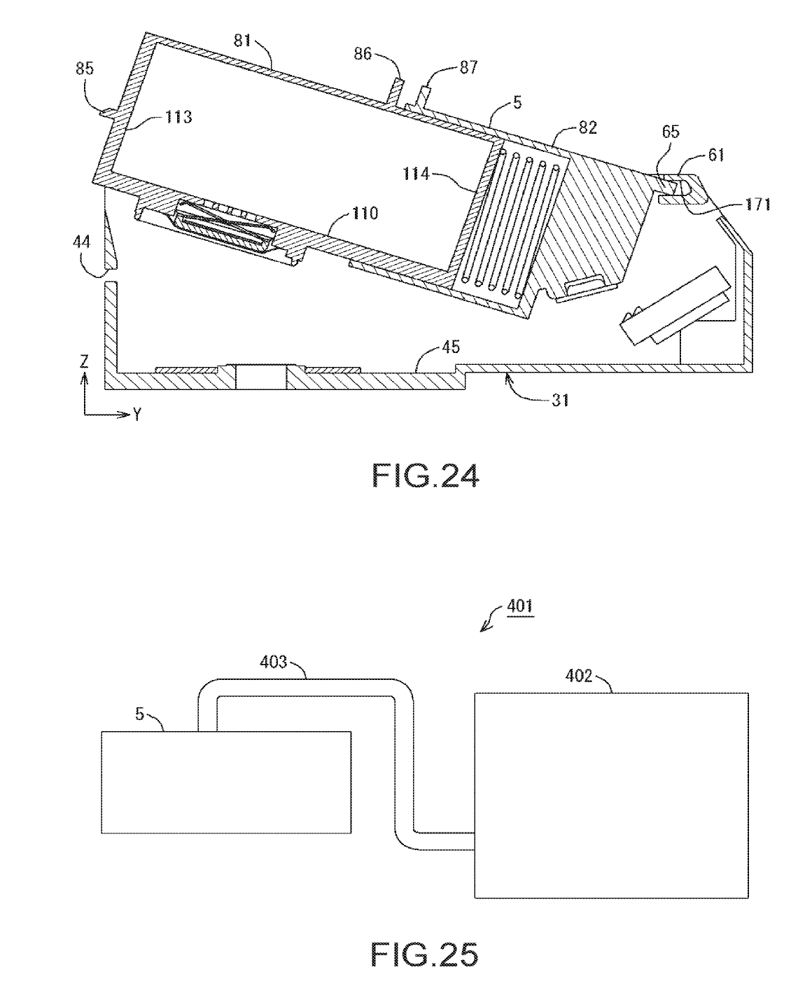

It should be noted that with respect to the above-described attachment method, a method is adopted in which, as shown in FIG. 22, the engagement protrusion 85 is inserted into the engagement hole 44 in a state in which the bottom wall 110 of the cartridge 5 is inclined in such a direction that the distance from the bottom portion 45 decreases toward the −Y-axis direction side. However, the attachment method is not limited to this. With respect to the attachment method, a method may also be adopted in which, as shown in FIG. 24, the engagement portion 65 is inserted into the engaged portion 61 in a state in which the bottom wall 110 of the cartridge 5 is inclined in such a direction that the distance from the bottom portion 45 decreases toward the Y-axis direction side. In this method, attachment of the cartridge 5 to the holder 31 is completed by rotating (pivoting) the cartridge 5 about the engagement portion 65 inserted in the engaged portion 61, the engagement portion 65 serving as a pivot point, in a direction in which the engagement protrusion 85 is brought nearer to the engagement hole 44.

The third embodiment also has similar effects to those of the first embodiment and the second embodiment. Moreover, in the present embodiment, in the state in which the cartridge 5 is attached to the printer 3, the second housing 82 is biased by the biasing member 88 in the direction along the reference surface 142. With this configuration, the state in which the engagement portion 65 engages with the engaged portion 61 and the state in which the engagement protrusion 85 engages with the engagement hole 44 as well as the state in which the contact mechanism 62 and the terminal portion 66 are in electrical contact with each other can be achieved by the biasing member 88 biasing the second housing 82 in the direction along the reference surface 142 and away from the first housing 81. Moreover, the state in which the engagement portion 65 engages with the engaged portion 61 and the state in which the engagement protrusion 85 engages with the engagement hole 44 as well as the state in which the contact mechanism 62 and the terminal portion 66 are in electrical contact with each other can be released by displacing the second housing 82 in the direction toward the first housing 81. Thus, it is possible to attach/remove the cartridge 5 to/from the printer 3 using a novel engagement mechanism that has not been proposed by related art. Therefore, levers can be omitted from the cartridge 5 and the carriage unit 25, so that the sizes of the cartridge 5 and the carriage unit 25 and hence the size of the printer 3 can be easily reduced.

### Fourth Embodiment

With respect to the cartridge 5 of the above-described third embodiment, a configuration in which ink is contained in the first housing 81 is adopted. However, the configuration of the cartridge 5 is not limited to this. With respect to the configuration of the cartridge 5, a configuration in which ink is contained in the second housing 82 may also be adopted. The configuration of the cartridge 5 in which ink is contained in the second housing 82 will be described as a fourth embodiment below. It should be noted that components of the fourth embodiment that are similar to those of the third embodiment are denoted by the same reference numerals as those of the third embodiment, and a detailed description thereof is omitted.

In the cartridge 5 of the fourth embodiment, the second housing 82 has the ink containing portion 147 and the ink supply portion 175. The first housing 81 is located on the −Y-axis direction side of the second housing 82. The engagement protrusion 85 is provided at an end portion of the first housing 81 with respect to the −Y-axis direction. The biasing member 88 is located on the −Y-axis direction side of the second housing 82. The biasing member 88 is held between the second housing 82 and the first housing 81. The method for attaching the cartridge 5 according to the fourth embodiment is similar to that of the third embodiment, and therefore a detailed description thereof is omitted. The fourth embodiment has similar effects to those of the third embodiment.

Modification 1

The liquid supply unit for supplying a liquid to a liquid ejection device is not limited to the cartridge 5, which is an example of the liquid supply unit. Another example of the liquid supply unit will be described as Modification 1. As shown in FIG. 25, a liquid supply unit 401 of Modification 1 has the above-described cartridge 5, a tank 402, and an ink supply tube 403. The tank 402 contains ink to be supplied to the above-described cartridge 5. The ink supply tube 403 directs a liquid from the tank 402 to the cartridge 5. The ink supply tube 403 has flexibility.

Moreover, in the liquid supply unit 401 of Modification 1, the cartridge 5 is installed in the carriage unit 25 (FIG. 2), whereas the tank 402 is provided independently of the carriage unit 25. That is to say, according to Modification 1, the tank 402 is not installed in the carriage unit 25. Therefore, it is possible to increase the amount of ink that can be supplied to the liquid ejection device while alleviating the load applied to the carriage unit 25. Furthermore, if a configuration in which the tank 402 can be refilled with new ink is adopted, downtime of the liquid ejection device due to exhaustion of ink can be reduced or eliminated.

The invention is not limited to inkjet printers and ink cartridges of the inkjet printers, and is also applicable to any printing device (liquid discharging device) that ejects (discharges) a liquid other than ink and a cartridge for that printing device. For example, the invention is applicable to various types of printing devices such as those described below and cartridges of those printing devices.

(1) Image recording devices such as facsimile machines. (2) Printing devices for use in manufacturing of color filters for image display devices such as liquid crystal displays, the printing devices ejecting a coloring material. (3) Printing devices for use in formation of electrodes of organic EL (electroluminescence) displays, surface discharging displays (field emission displays, FEDs), and the like, the printing device ejecting an electrode material. (4) Printing devices for use in manufacturing of biochips, the printing devices ejecting a liquid containing a bioorganic substance. (5) Specimen printing devices serving as precision pipettes. (6) Lubricant printing devices. (7) Resin solution printing devices. (8) Printing devices ejecting a lubricant onto precision machines such as timepieces and cameras with a pinpoint accuracy. (9) Printing devices ejecting a transparent resin solution such as an ultraviolet curable resin solution onto a substrate in order to form a micro hemispherical lens (optical lens) for use in an optical communication element and the like. (10) Printing devices ejecting an acidic or alkali etchant in order to etch a substrate or the like. (11) Any other printing devices provided with a liquid ejection head (liquid discharging head) that discharges a minute amount of liquid droplets.

It should be noted that “liquid droplets” refers to a state of the liquid discharged from the printing device, and may also include granular shapes, teardrop shapes, and thread-like shapes, which leave long, thin trails. Moreover, “liquid” can be any material that can be ejected by the printing device. For example, “liquid” can be any material in a state of a substance in the liquid phase, and materials in a state of a liquid having high or low viscosity as well as materials in a state of a sol, gel water, or any other liquid such as an inorganic solvent, an organic solvent, a solution, a liquid resin, or a liquid metal (metallic melt) are also included in the “liquid”. Moreover, the “liquid” is not limited only to the liquid as one state of substances, and may also include materials in which particles of a pigment or a functional material composed of solid matter such as metal particles are dissolved, dispersed, or mixed in a solvent. The “liquid” as described above can also be expressed as “liquid-like body”. Representative examples of the liquid and the liquid-like body include ink as described in the foregoing embodiments, liquid crystal, and the like. It is to be understood that the ink as used herein includes various types of liquid compositions such as common water-based and oil-based ink as well as gel ink, hot melt ink, and the like.

This application is a continuation of U.S. application Ser. No. 14/988,353 filed Jan. 5, 2016, which claims priority to Japanese Patent Application Nos: 2015-000674 filed on Jan. 6, 2015 and 2015-154817 filed on Aug. 5, 2015, the entireties of which are expressly incorporated by reference herein.

What is claimed is:

1. A liquid supply unit, adapted to supply a liquid to and be removably attached to a holder provided in a liquid ejection device, the holder including a first engaged portion, a second engaged portion, an electrode portion having an electrode pin, and a liquid introduction portion, the liquid supply unit comprising:
a first housing including:
a liquid containing portion,
a bottom wall having a liquid supply portion,
a top wall opposed to the bottom wall in a Z-direction,
a first side wall intersecting the bottom wall and the top wall and having a first engagement portion engageable with the first engaged portion of the holder, and
a second side wall intersecting the bottom wall and the top wall and opposed to the first side wall in a Y-direction intersecting the Z-direction;
a second housing including:
a top wall facing at least a part of the top wall of the first housing in the Z-direction, and
a third side wall intersecting the top wall, the third side wall having an outer surface having a terminal portion to come into electrical contact with the electrode portion and a second engagement portion engageable with the second engaged portion, and the third side wall having an inner surface opposed to the second side wall of the first housing in the Y-direction; and
a biasing member held between the second side wall of the first housing and the inner surface of the third side wall of the second housing so that the first housing, the biasing member, and the second housing are arranged to be disposed between the first engaged portion and the second engaged portion in the Y-direction, the biasing member biasing the second housing in a biasing direction away from the first housing in the Y-direction, in a state in which the liquid supply unit is attached to the holder.

2. The liquid supply unit according to claim 1,
wherein the liquid supply portion includes a liquid supply port and a wall portion surrounding the liquid supply port.

3. The liquid supply unit according to claim 1, further comprising:
a first operating portion located on the top wall of the first housing, the first operating portion used to elastically deform the biasing member and move a position of the first housing relative to the second housing.

4. The liquid supply unit according to claim 1, further comprising:
a second operating portion located on the top wall of the second housing, the second operating portion used to elastically deform the biasing member and move a position of the second housing relative to the first housing.

5. The liquid supply unit according to claim 1, further comprising:
a first operating portion located on a top wall of the first housing, the first operating portion used to elastically deform the biasing member and move a position of the first housing relative to the second housing; and
a second operating portion located on the top wall of the second housing, the second operating portion used to elastically deform the biasing member and move a position of the second housing relative to the first housing.

6. The liquid supply unit according to claim 5,
wherein the first operating portion and the second operating portion are substantially the same height.

7. The liquid supply unit according to claim 1,
wherein the first housing has a first guide portion, and the second housing has a second guide portion adapted to come into contact with the first guide portion, the first guide portion and the second guide portion extending in the Y-direction.

8. A liquid supply unit, adapted to supply a liquid to and be removably attached to a holder provided in a liquid ejection device, the holder including a first engaged portion, a second engaged portion, an electrode portion having an electrode pin, and a liquid introduction portion, the liquid supply unit comprising:
a first housing including:
a top wall, and
a first side wall intersecting the top wall, the first side wall having an outer surface having a first engagement portion engageable with the first engaged portion of the holder, and the first side wall having an inner surface;
a second housing including:
a liquid containing portion,
a bottom wall having a liquid supply portion,
a top wall opposed to the bottom wall in a Z-direction, the top wall facing at least a part of the top wall of the first housing in the Z-direction,
a second side wall intersecting the bottom wall and the top wall, the second side surface opposing the inner surface of the first side wall of the first housing in a Y-direction intersecting the Z-direction, and
a third side wall intersecting the top wall and the bottom wall and opposed to the second side wall in the Y-direction, the third side wall having a terminal portion to come into electrical contact with the electrode portion and having a second engagement portion engageable with the second engaged portion; and
a biasing member held between the inner surface of the first side wall of the first housing and the second side wall of the second housing so that the first housing, the biasing member, and the second housing are arranged to be disposed between the first engaged portion and the second engaged portion in the Y-direction, the biasing member biasing the second housing in a biasing direction away from the first housing in the Y-direction, in a state in which the liquid supply unit is attached to the holder.

9. The liquid supply unit according to claim 8,
wherein the liquid supply portion includes a liquid supply port and a wall portion surrounding the liquid supply port.

10. The liquid supply unit according to claim 8, further comprising:
a first operating portion located on the top wall of the first housing, the first operating portion used to elastically deform the biasing member and move a position of the first housing relative to the second housing.

11. The liquid supply unit according to claim 8, further comprising:
a second operating portion located on the top wall of the second housing, the second operating portion used to elastically deform the biasing member and move a position of the second housing relative to the first housing.

12. The liquid supply unit according to claim 8, further comprising:
a first operating portion located on a top wall of the first housing, the first operating portion used to elastically deform the biasing member and move a position of the first housing relative to the second housing; and
a second operating portion located on the top wall of the second housing, the second operating portion used to elastically deform the biasing member and move a position of the second housing relative to the first housing.

13. The liquid supply unit according to claim 12,
wherein the first operating portion and the second operating portion are substantially the same height.

14. The liquid supply unit according to claim 8,
wherein the first housing has a first guide portion, and the second housing has a second guide portion adapted to come into contact with the first guide portion, the first guide portion and the second guide portion extending in the Y-direction.
